(19) United States
(12) Patent Application Publication
(10) Pub. No.: US 2011/0031804 A1
(43) Pub. Date: Feb. 10, 2011

(54) BRAKING SYSTEM

(75) Inventors: Michihito Shimada, Shizuoka-ken (JP); Kazuya Maki, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi, Aichi-ken (JP)

(21) Appl. No.: 12/937,330

(22) PCT Filed: Apr. 9, 2009
(86) PCT No.: PCT/IB09/05216

§ 371 Date: Oct. 11, 2010

(30) Foreign Application Priority Data
Apr. 11, 2008 (JP) 2008-104-02

(51) Int. Cl. B60T 8/32; B60T 13/12; B60T 13/58; B60T 8/34; B60T 8/94

(52) U.S. Cl. 303/2; 303/9.75; 303/121; 303/152

(57) ABSTRACT

A braking system includes: a first connecting line (L18) that connects an upstream side of a 11-system valve (25b) and a 12-system valve (25c) within a first system (25) to any one of a position between a 21-system valve (26b) and a left front wheel cylinder (27c) or a position between a 22-system valve (26c) and a right rear wheel cylinder (27d); a second connecting line (L28) that connects an upstream side of the 21-system valve (26b) and 22-system valve (26c) within the second system (26) to any one of a position between the 12-system valve (25c) and a left rear wheel cylinder (27b) or a position between the 11-system valve (25b) and a right front wheel cylinder (27a); a first changeover valve (25d) that is provided in the first connecting line (L18); and a second changeover valve (26d) that is provided in the second connecting line (L28).

### BACKGROUND OF THE INVENTION

1. Field of the Invention

The invention relates to a braking system and, more particularly, to a braking system that includes a first braking system that exerts a braking force on a right front wheel and a left rear wheel and a second braking system that exerts a braking force on a left front wheel and a right rear wheel.

2. Description of the Related Art

Some braking systems pressurize a hydraulic fluid in accordance with driver's braking operation, and supply the pressurized hydraulic fluid to wheel cylinders of front and rear wheels of a vehicle, thus exerting a. pressure braking force on the front and rear wheels. Some of the above braking systems include a first system and a second system. The first system supplies a pressurized hydraulic fluid to a right front wheel cylinder provided for a right front wheel and a left rear wheel cylinder provided for a left rear wheel. The second system supplies a pressurized hydraulic fluid to a left front wheel cylinder provided for a left front wheel and a right rear wheel cylinder provided for a right rear wheel. That is, the pressure braking system includes diagonal lines that are connected to the wheels for supplying a hydraulic fluid. The braking system equipped with a diagonally split pressure braking system exerts a pressure braking force on a set of diagonally opposite wheels of the vehicle. For example, in a so-called FF vehicle in which an engine is mounted at the front of the vehicle and front wheels serve as drive wheels, a load on the front wheels is large. Iii the FF vehicle, even when a failure occurs in any one of the first system and the second system, it is possible to exert a pressure braking force on a set of front and rear wheels. Thus, stability of behavior of the vehicle may be ensured during braking.

Japanese Patent Application Publication No. 2004-276666 (JP-A-2004-276666) describes a braking system that includes a pressure braking system and a regenerative, braking system. The pressure braking .system exerts a pressure braking force based on a wheel cylinder pressure of each wheel cylinder on each of the wheels of the vehicle. The regenerative braking system exerts a regenerative braking force on at least any one of the front wheels and rear wheels of the vehicle. Then, the pressure braking system compensates for an insufficient braking force due to variations in regenerative braking force. The pressure braking system described in JP-A-2004-276666 includes a first system that supplies a pressurized hydraulic fluid to a front wheel cylinder provided for each front wheel and a second system that supplies a pressurized hydraulic fluid to a rear wheel cylinder provided for each rear wheel. That is, the pressure braking system described in JP-A-2004-276666 is of a front/rear split type in which lines that supply a hydraulic fluid are respectively connected to the front and rear wheels. The braking system equipped with a front/rear split pressure braking system distributes a pressure braking force between a front wheel braking force exerted on the front wheels of the vehicle and a rear wheel braking force exerted on the rear wheels of the vehicle.

However, the braking system equipped with a diagonally split pressure braking system is not able to distribute a pressure braking force between a front wheel pressure braking force exerted on the front wheels of the vehicle and a rear wheel pressure braking force exerted on the rear wheels of the vehicle unlike the braking system that includes a front/rear split pressure braking system. Thus, it is impossible to distribute a braking force between a front wheel braking force and a rear wheel braking force. On the other hand, the braking system equipped with a front/rear split pressure braking system is not able to exert a pressure braking force on a set of front and rear wheels when a failure occurs in any one of the first system and the second system unlike the braking system equipped with a diagonally split pressure braking system. Thus, there is a possibility that stability of the behavior of the vehicle may decrease during braking.

### SUMMARY OF THE INVENTION

The invention provides a braking system that is able to exert a braking force on a set of diagonally opposite wheels of a vehicle and that is able to distribute a braking force between a front wheel braking force and a rear wheel braking force.

According to an embodiment of the invention, a braking system that pressurizes a hydraulic fluid in accordance with driver's braking operation to exert a pressure braking force on a vehicle, the braking system includes: a brake pedal that is operated by the driver; an operating pressure apply unit that applies an operating pressure to the hydraulic fluid in accordance with driver's operation of the brake pedal; a first system that supplies the pressurized hydraulic fluid to a right front wheel cylinder provided for a right front wheel and a left rear wheel cylinder provided for a left rear wheel; a second system that supplies the pressurized hydraulic fluid to a left front wheel cylinder provided for a left front wheel and a right rear wheel cylinder provided for a right rear wheel; a 11-system valve that is provided upstream of the right front wheel cylinder within the first system; a 12-system valve that is provided upstream of the left rear wheel cylinder within the first system; a 21-system valve that is provided upstream of the left front wheel cylinder within the second system; a 22-system valve that is provided upstream of the right rear wheel cylinder within the second system; a first connecting line that connects an upstream side of the 11-system valve and 12-system valve within the first system to any one of a position between the 21-system valve and the left front wheel cylinder or a position between the 22-system valve and the right rear wheel cylinder; a second connecting line that connects an upstream side of the 21-system valve and 22-system valve within the second system to any one of a position between the 12-system valve and the left rear wheel cylinder or a position between the 11-system valve and the right front wheel cylinder; a first changeover valve that is provided in the first connecting line; and a second changeover valve that is provided in the second connecting line.

In the braking system according to the embodiment, the first connecting line may connect an upstream side of the 11-system valve and the 12-system valve within the first system to a position between the 21-system valve and the left front wheel cylinder, and the second connecting line may connect an upstream side of the 21-system valve and the 22-system valve within the second system to a position between the 12-system valve and the left rear wheel cylinder. Alternatively, the first connecting line may connect an upstream side of the 11-system valve and the 12-system valve within the first system to a position between the 22-system valve and the right rear wheel cylinder, and the second connecting line may connect an upstream side of the 21-system valve and the 22-system valve within the second system to a position between the 11-system valve and the right front wheel cylinder.

In the braking system according to the embodiment, the braking system may further include a control unit that at least controls opening and closing of each of the valves, wherein the control unit may switch a braking mode between a front/rear braking mode and a diagonal braking mode, in the front/rear braking mode, the first changeover valve and the second changeover valve may be opened, one of the 11-system valve and the 12-system valve, connected to the second connecting line, may be closed and the other one of the 11-system valve and the 12-system valve may be opened, and one of the 21-system valve and the 22-system valve, connected to the first connecting line, may be closed and the other one of the 21-system valve and the 22-system valve may be opened, and in the diagonal braking mode, the first changeover valve and the second changeover valve may be closed, the 11-system valve and the 12-system valve may be opened, and the 21-system valve and the 22-system valve may be opened.

With the braking system according to the embodiment of the invention, the first changeover valve and the second changeover valve are opened, one of the 11-system valve and 12-system valve, connected to the second connecting line, is closed and the other one of the 11-system valve and 12-system valve is opened, and one of the 21-system valve and 22-system valve, connected to the first connecting line, is closed and the other one of the 21-system valve and 22-system valve is opened. Thus, it is possible to exert a front wheel braking force on the front wheels of the vehicle using the first system, and it is possible to exert a rear wheel braking force on the rear wheels of the vehicle using the second system. In addition, the first changeover valve and the second changeover valve are closed, the 11-system valve and the 12-system valve are opened, and the 21-system valve and the 22-system valve are opened. Thus, the first system and the second system are able to respectively exert braking forces on sets of the diagonally opposite wheels of the vehicle. Thus, it is possible to exert a braking force on sets of the diagonally opposite wheels of the vehicle, and it is also possible to distribute a braking force between a front wheel braking force and a rear wheel braking force.

In the braking system according to the embodiment, the braking system may further include an abnormality detecting unit that detects an abnormality of at least any one of the first system and the second system, wherein the control unit may switch the braking mode to the front/rear braking mode when no abnormality is detected, and may switch the braking mode to the diagonal braking mode when the abnormality is detected.

With the braking system according to the above embodiment, when an abnormality is detected, any one of the first system and the second system exerts a braking force on a corresponding one of the sets of the diagonally opposite wheels of the vehicle. Thus, it is possible to maintain stability of the behavior of the vehicle in the event of an abnormality.

In the braking system according to the embodiment, the braking system may further include: a required braking force setting unit that sets a required braking force in accordance with the driver's braking operation; and a pressurizing unit that respectively pressurizes a first system hydraulic fluid in the first system and a second system hydraulic fluid in the second system on the basis of the set required braking force, and applies pressures respectively to the first system hydraulic fluid and the second system hydraulic fluid, wherein the control unit may perform pressurizing control such that the pressures applied respectively to the first system hydraulic fluid and the second system hydraulic fluid by the pressurizing unit are separately controlled.

In the braking system according to the embodiment, the braking system may further include a distribution ratio setting unit that sets a front/rear distribution ratio, which is the ratio between a front wheel braking force exerted on the front wheels of the vehicle and a rear wheel braking force exerted on the rear wheels of the vehicle for the braking force exerted on the vehicle in the front/rear braking mode, wherein the control unit may perform the pressurizing control on the basis of the set front/rear distribution ratio.

With the braking system according to the above embodiment, in the front/rear braking mode, a pressure applied to the first system hydraulic fluid is exerted on the wheel cylinders corresponding to the front wheels of the vehicle, and a pressure applied to the second system hydraulic fluid is exerted on the wheel cylinders corresponding to the rear wheels of the vehicle. Thus, by performing pressurizing control such that a pressure applied to the, first system hydraulic fluid and a pressure applied to the second system hydraulic fluid are, for example, separately controlled on the basis of the set front/rear distribution ratio, it is possible to selectively exert a front wheel braking force and a rear wheel braking force on the vehicle.

With the braking system according to the embodiment, in the diagonal braking mode, a pressure applied to the first system hydraulic fluid is exerted on one of the sets of the wheel cylinders corresponding to the diagonally opposite wheels of the vehicle, and a pressure applied to the second system hydraulic fluid is exerted on the other one of the sets of the wheel cylinders corresponding to the diagonally opposite wheels of the vehicle. Thus, by performing pressurizing control such that a pressure applied to the first system hydraulic fluid and a pressure applied to the second system hydraulic fluid are, for example, separately controlled on the basis of the set front/rear distribution ratio, even when any one of the first system and the second system has an abnormality, it is possible to respectively exert a front wheel braking force and a rear wheel braking force on one of the sets of the diagonally opposite wheels of the vehicle using any one of the systems.

In the braking system according to the embodiment, the braking system may further include an acceleration detecting unit that detects an acceleration of the vehicle, wherein the distribution ratio setting unit may set the front/rear distribution ratio on the basis of the detected acceleration.

With the braking system according to the above embodiment, in the front/rear braking mode, the front/rear distribution ratio is set on the basis of the detected acceleration. Thus, even when the braking force is exerted on the vehicle and, as a result, a front wheel load on the front wheels of the vehicle and a rear wheel load on the rear wheels of the vehicle shift from the front wheel load and the rear wheel load during the vehicle is standing still, it is possible to distribute the braking force between a front wheel braking force and a rear wheel braking force in consideration of the load shift. Thus, it is possible to improve stability of the behavior of the vehicle at the time of braking.

In the braking system according to the embodiment, the braking system may further include: a regenerative braking unit that exerts a regenerative braking force on at least any one of the front wheels of the vehicle and the rear wheels of the vehicle; and a regenerative braking force setting unit that sets a target regenerative braking force, wherein the control unit may perform the pressurizing control when the sum of the pressure braking force based on the operating pressure and the regenerative braking force based on the set target regenerative braking force is smaller than the set required braking force.

With the braking system according to the above embodiment, it is possible to exert a braking force on sets of the diagonally opposite wheels of the vehicle, and it is also possible to distribute a braking force including a regenerative braking force between a front wheel braking force and a rear wheel braking force.

In the braking system according to the embodiment, in the front/rear braking mode, the control unit may at least switch a regenerative mode of the regenerative braking unit between a distribution priority mode and a fuel economy priority mode, and the regenerative braking force setting unit may set the target regenerative braking force so as to be larger in the fuel economy priority mode than in the distribution priority mode. In addition, the regenerative mode ma_{y} be switched on the basis of a state of a battery that constitutes the regenerative braking force setting unit, and the regenerative mode may be switched to the distribution priority mode when the state of the battery, that is, for example, the SOC is high.

In the braking system according to the embodiment, the regenerative mode may be switched on the basis of at least any one of a state of deceleration of the vehicle and a frictional condition of a road surface on which the vehicle runs.

With the braking system according to the above embodiment, when stability of the behavior of the vehicle is likely to decrease, the front/rear distribution ratio is maintained to distribute a braking force including a regenerative braking force between a front wheel braking force and a rear wheel braking force rather than regenerative braking performed by the regenerative braking unit. Thus, it is possible to suppress a decrease in stability.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is. a view that shows a schematic configuration example of a braking system according to a first embodiment;

FIG. 2 is a view that shows a schematic configuration example of a pressure braking system in a diagonal braking mode;

FIG. 3 is a view that shows a schematic configuration example of the pressure braking system in a front/rear braking mode;

FIG. 4A-4B is a flowchart of a method of controlling the braking system according to the first embodiment;

FIG. 5 is a view that shows a schematic configuration example of a braking system according to a second embodiment;

FIG. 6A-6B is a flowchart of a method of controlling the braking system according to the second embodiment;

FIG. 7 is a view that shows a schematic configuration example of a braking system according to third and fourth embodiments;

FIG. 8A-8B is a flowchart of a method of controlling the braking system according to the third embodiment;

FIG. 9A-9B is a flowchart of a method of controlling the braking system according to the fourth embodiment;

FIG. 10 is a view that shows a schematic configuration example of a pressure braking system in a diagonal braking mode according to an alternative embodiment to the first embodiment; and

FIG. 11 is a view that shows a schematic configuration example of the pressure braking system in a front/rear braking mode according to the alternative embodiment to the first embodiment.

### DETAILED DESCRIPTION OF EMBODIMENTS

Hereinafter, embodiments of the invention will be described with reference to the accompanying drawings, Note that the following embodiments are not intended to limit the scope of the invention. In addition, components described in the following embodiments encompass components that can be easily come up with by a person skilled in the art and substantially equivalent components.

### First Embodiment

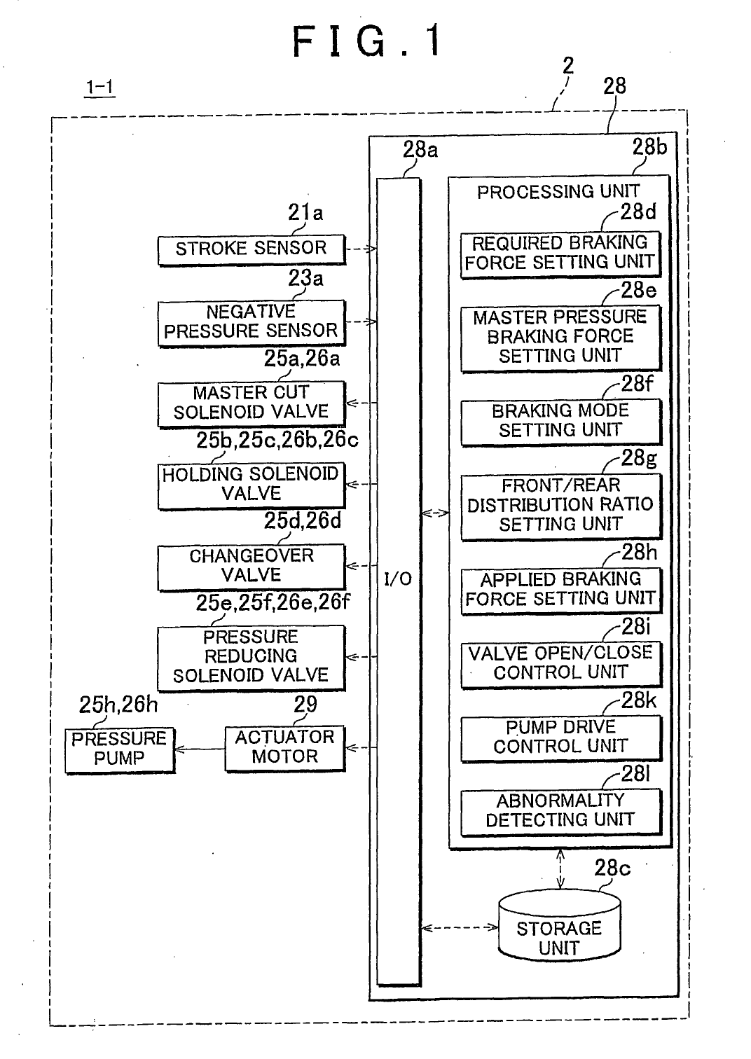

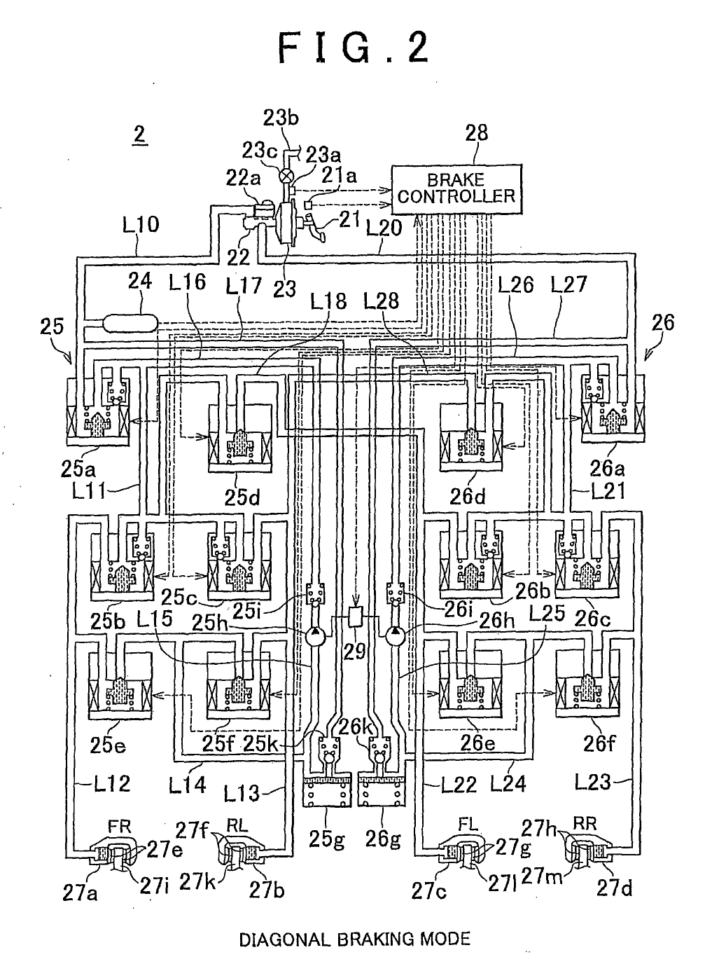

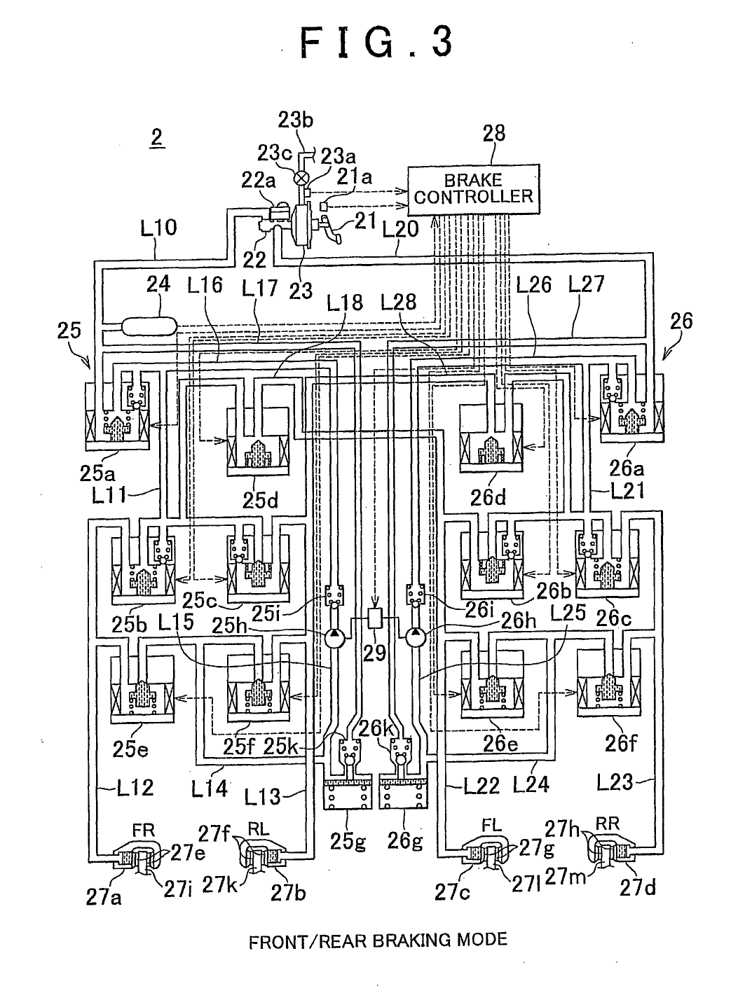

FIG. 1 is a view that shows a schematic configuration example of a braking system according to a first embodiment. FIG. 2 is a view that shows a schematic configuration example of a pressure braking system in a diagonal braking mode. FIG. 3 is a view that shows a schematic configuration example of the pressure braking system in a front/rear braking mode. As shown in FIG. 1 and FIG. 2, a braking system 1-1 according to the first embodiment is mounted on a vehicle (not shown; hereinafter, simply referred to as “vehicle CA”) equipped with only an internal combustion engine (not shown). The braking system 1-1 includes a pressure braking system 2.

The pressure braking system 2 generates a pressure braking force. In the first embodiment, as shown in FIG. 2, the pressure braking system 2 includes a brake pedal 21, a master cylinder 22, a brake booster 23, a master cylinder pressure sensor 24, a first system 25, a second system 26, a right front wheel cylinder 27a (hereinafter, simply referred to as “FR cylinder 27a”) provided for a right front wheel (not shown), a left rear wheel cylinder 27b (hereinafter, simply referred to as “RL cylinder 27b”) provided for a left rear wheel (not shown), a left front wheel cylinder 27c (hereinafter, simply referred to as “FL cylinder 27c”) provided for a left front wheel (not shown), a right rear wheel cylinder 27d (hereinafter, simply referred to as “RR cylinder 27d”) provided for a right rear wheel (not shown), and a brake controller 28. Here, in the pressure braking system 2, a brake fluid OIL, which is a hydraulic fluid, fills the master cylinder 22, the first system 25, the second system 26, and the wheel cylinders 27a to 27d. The pressure braking system 2 basically pressurizes the brake fluid OIL in accordance with driver's braking operation, and supplies the pressurized brake fluid to the wheel cylinders 27a to 27d to exert a pressure braking force on the wheels (not shown) of the vehicle CA. In the first embodiment, basically, as the driver depresses, the brake pedal 21, the master cylinder 22 applies an operating pressure to the brake fluid OIL on the basis of a depression force exerted on the brake pedal 21. The operating pressure, that is, a master cylinder pressure PMC, is exerted on the wheel cylinders 27a to 27d as equal wheel cylinder pressures PWC. Then, a master pressure braking force, which is a pressure braking force based on the operating pressure, is exerted on the wheels of the vehicle CA.

The brake pedal 21 is operated when the driver causes the vehicle CA to generate a braking force, that is, depending on a driver's braking request. The brake pedal 21 is equipped with a stroke sensor 21a. The stroke sensor 21a is a stroke detecting unit. The stroke sensor 21 a detects an amount of depression by which the brake pedal 21 is depressed by the driver, that is, a pedal stroke ST of the brake pedal 21. The stroke sensor 21 a is connected to the brake controller 28. The pedal stroke ST of the brake pedal 21, detected by the stroke sensor 21a, is output to the brake controller 28.

The master cylinder 22 is an operating pressure apply unit. The master cylinder 22 pressurizes a brake fluid OIL, which is a hydraulic fluid, in accordance with driver's operation of the brake pedal 21 to apply the master cylinder pressure PMC, which is the operating pressure. The master cylinder 22 pressurizes the brake fluid OIL by a piston (not shown). A depression force exerted on the brake pedal 21 is applied to the piston as the driver depresses the brake pedal 21. Note that the master cylinder 22 includes a reservoir 22a. The reservoir 22a stores a brake fluid used in the pressure braking system.

The brake booster 23 is a vacuum booster. The brake booster 23 uses a negative pressure generated by the internal combustion engine (not shown) to amplify a depression force exerted on the brake pedal 21 when the driver depresses the brake pedal 21. The brake booster 23 is connected to an intake passage (not shown) of the internal combustion engine via a negative pressure line. 23c and a check valve 23b. The brake booster 23 amplifies a depression force by a force exerted on a diaphragm (not shown) on the basis of a differential pressure between a negative pressure generated in the intake passage of the internal combustion engine and an outside-air pressure. Thus, in the first embodiment, in accordance with the depression force exerted on the brake pedal 21 and amplified by the brake booster 23, the master cylinder 22 pressurizes the brake fluid OIL to apply an operating pressure to the brake fluid OIL. That is, the brake booster 23 constitutes part of the operating pressure apply unit. Thus, the operating pressure is based on a depression force exerted on the brake pedal 21 by the driver and a negative pressure in the intake passage of the internal combustion engine. Here, the brake booster 23 has a negative pressure sensor 23a provided in the negative pressure line 23b. The negative pressure sensor 23a detects a pressure in the negative pressure line 23b as a negative pressure PV of the brake booster 23. The negative pressure sensor 23a is connected to the brake controller 28. The negative pressure PV detected by the negative pressure sensor 23a is output to the brake controller 28. Note that the master cylinder 22 and the brake booster 23 are configured so that a pressure braking force based on an operating pressure is smaller than a required braking force based on a driver's braking request. That is, a pressure braking force based on an operating pressure is smaller than that of a typical pressure braking system 2. This is because it is possible to selectively distribute a braking force between a front wheel braking force and a rear wheel braking force by increasing an applied braking force based on a pressure with respect to a required braking force. The front wheel braking force is exerted on the front wheels (not shown) of the vehicle CA in the first system 25, which will be described later. The rear wheel braking force is exerted on the rear wheels (not shown) of the vehicle CA in the second system 26.

The master cylinder pressure sensor 24 is an operating pressure detecting unit. The master cylinder pressure sensor 24 detects an operating pressure. In the first embodiment, the master cylinder pressure sensor 24 is provided in a hydraulic line L10 that connects the master cylinder 22 to a master cut solenoid valve 25a, which will be described later, of the first system 25. That is, the master cylinder pressure sensor 24 detects the pressure of the brake fluid OIL in the hydraulic line L10 as the operating pressure, that is, the master cylinder pressure PMC. The master cylinder pressure sensor 24 is connected to the brake controller 28. The master cylinder pressure PMC detected by the master cylinder pressure sensor 24 is output to the brake controller 28.

The first system 25 supplies a pressurized brake fluid OIL to the FR cylinder 27a and the RL cylinder 27b. That is, the first system 25 controls wheel cylinder pressures PWC exerted respectively on the FR cylinder 27a and the RL cylinder 27b in accordance with the master cylinder pressure PMC applied to the brake fluid OIL by the master cylinder 22, or exerts wheel cylinder pressures PWC respectively to the FR cylinder 27a and the RL cylinder 27b irrespective of whether the master cylinder pressure PMC is applied to the brake fluid OIL by the master cylinder 22. The first system 25 is formed of the master cylinder 22, the brake booster 23, the master cut solenoid valve 25a, holding solenoid valves 25b and 25c, a first changeover valve 25d, pressure reducing solenoid valves 25e and 25f, a reservoir 25g, a pressure pump 25h, check valves 25i and 25k, hydraulic lines L10 to L17, and a first connecting line L18.

The second system 26 supplies a pressurized brake fluid OIL to the FL cylinder 27c and the RR cylinder 27d. That is, the second system 26 controls wheel cylinder pressures PWC exerted respectively on the FL cylinder 27c and the RR cylinder 27d in accordance with the master cylinder pressure PMC applied to the brake fluid OIL by the master cylinder 22, or exerts wheel cylinder pressures PWC respectively to the FL cylinder 27c and the RR cylinder 27d irrespective of whether the master cylinder pressure PMC is applied to the brake fluid OIL by the master cylinder 22. The. second system 26 is formed of the master cylinder 22, the brake booster 23, a master cut solenoid valve 26a, holding solenoid valves 26b and 26c, a second changeover valve 26d, pressure reducing solenoid valves 26e and 26f, a reservoir 26g, a pressure pump 26h, check valves 26i and 26k, hydraulic lines L20 to L27, and a second connecting line L28. Note that the first system 25 and the second system 26 each are supplied with the brake fluid OIL of the same pressure (master cylinder pressure PMC) from the master cylinder 22. In addition, an actuator motor 29 drives the pressure pumps 25h and 26h.

The master cut solenoid valves 25a and 26a are pressure regulating units that constitute a pressurizing unit. The master cut solenoid valve 25a regulates an applied pressure Pp1 applied to a brake fluid OIL1 that is supplied to the first system 25. The brake fluid OIL1 is a first system hydraulic fluid in the first system 25 within the brake fluid OIL. The master cut solenoid valve 26a regulates an applied pressure Pp2 applied to a brake fluid OIL2 that is supplied to the second system 26. The brake fluid OIL2 is a second system hydraulic fluid in the second system 26 within the brake fluid OIL. The master cut solenoid valve 25a is connected to the hydraulic line L10 and the hydraulic line L11. The master cut solenoid valve 25a allows or interrupts fluid communication between the hydraulic line L10 and the hydraulic line L11, and regulates a differential pressure between the upstream side and downstream side of the master cut solenoid valve 25a during fluid communication. That is, the master cut solenoid valve 25a adjusts a differential pressure between the pressure of the brake fluid OIL1 pressurized by the pressure pump 25h and the master cylinder pressure PMC as the applied pressure Pp1. In addition, the master cut solenoid valve 26a is connected to the hydraulic line L20 and the hydraulic line L21. The master cut solenoid valve 26a allows or interrupts fluid communication between the hydraulic line L20 and the hydraulic line L21, and regulates a differential pressure between the upstream side and downstream side of the master cut solenoid valve 26a during fluid communication. That is, the master cut solenoid valve 26a adjusts a differential pressure between the pressure of the brake fluid OIL2 pressurized by the pressure pump 26h and the master cylinder pressure PMC as the applied pressure Pp2. The master cut solenoid valves 25a and 26a are linear solenoid valves and are connected to the brake controller 28. Thus, an electric current supplied to each of the master cut solenoid valves 25a and 26a is controlled on the basis of a command electric current value issued from a valve open/close control unit 28i, which will be described later, of the brake controller 28 to thereby control the degree of opening of a corresponding one of the master cut solenoid valves 25a and 26a. In this way, the master cut solenoid valves 25a and 26a respectively regulate pressures Pp1 and Pp2 in accordance with the command electric current values. That is, the brake controller 28 separately controls the applied pressure Pp1 applied to the brake fluid OIL1 by the pressure pump 25h using the master cut solenoid valve 25a and the applied pressure Pp2 applied to the brake fluid OIL2 by the pressure pump 26h using the master cut solenoid valve 26a. Note that the master cut solenoid valves 25a and 26a each are fully open when no electric current is supplied thereto, that is, when de-energized.

The holding solenoid valve 25b is a 11-system valve provided in the first system 25, and handles the FR cylinder 27a. The holding solenoid valve 25b is connected to both the hydraulic line L11 connected to the master cylinder 22 and the hydraulic line L12 connected to the FR cylinder 27a. The holding solenoid valve 25b allows or interrupts fluid communication between the hydraulic line L11 and the hydraulic line L12. That is, the holding solenoid valve 25b is provided upstream of the FR cylinder 27a within the first system 25, and allows or interrupts connection between the master cylinder 22 and the FR cylinder 27a In addition, the holding solenoid valve 25c is a 12-system valve provided in the first system 25, and handles the RL cylinder 27b. The holding solenoid valve 25c is connected to both the hydraulic line L11 connected to the master cylinder 22 and the hydraulic line L13, which is a first cylinder line, connected to the RL cylinder 27b. The holding solenoid valve 25c allows or interrupts fluid communication between the hydraulic line L11 and the hydraulic line L13. That is, the holding solenoid valve 25c is provided upstream of the RL cylinder 27b within the first system 25, and allows or interrupts connection between the master cylinder 22 and the RL cylinder 27b. In addition, the holding solenoid valve 26b is a 21-system valve provided in the second system 26, and handles the FL cylinder 27c. The holding solenoid valve 26b is connected to both the hydraulic line L21 connected to the master cylinder 22 and the hydraulic line L22, which is a second cylinder line, connected to the FL cylinder 27c. The holding solenoid valve 26b allows or interrupts fluid communication between the hydraulic line L21 and the hydraulic line L22. That is, the holding solenoid valve 26b is provided upstream of the FL cylinder 27c within the second system 26, and allows or interrupts connection between the master cylinder 22 and the FL cylinder 27c. In addition, the holding solenoid valve 26c is a 22-system valve provided in the second system 26, and handles the RR cylinder 27d. The holding solenoid valve 26c is connected to both the hydraulic line L21 connected to the master cylinder 22 and the hydraulic line L23, which is a second cylinder line, connected to the RR cylinder 27d. The holding solenoid valve 26c allows or interrupts fluid communication between the hydraulic line L21 and the hydraulic line L23. That is, the holding solenoid valve 26c is provided upstream of the RR cylinder 27d within the second system 26, and allows or interrupts connection between the master cylinder 22 and the RR cylinder 27d. Each of the holding solenoid valves 25b, 25c, 26b and 26c is a normally open solenoid valve, and is connected to the brake controller 28. Thus, each of the holding solenoid valves 25b, 25c, 26b and 26c is controlled for opening and closing so that the on/off state of each of the holding solenoid valves 25b, 25c, 26b and 26c is controlled by the valve open/close control unit 28l of the brake controller 28. Each of the holding solenoid valves 25b, 25c, 26b and 26c is energized when it is turned on by the brake controller 28, and is fully open when energized. On the other hand, each of the holding solenoid valves 25b, 25c, 26b and 26c is de-energized when it is turned off by the brake controller 28, and is fully closed when de-energized. The holding solenoid valves 25b, 25c, 26b and 26c respectively include check valves that return a brake fluid OIL to the upstream side (hydraulic line L11 or L21 side) of the ,holding solenoid valves 25b, 25c, 26b and 26c when the downstream pressure is higher than the upstream pressure during energization.

The first changeover valve 25d is provided in the first connecting line L18, and handles the FL cylinder 27c. In the first embodiment, one end of the first connecting line L18 is connected to the upstream side of the holding solenoid valve 25b and holding solenoid valve 25c within the first system 25, that is, the hydraulic line L11. In addition, the other end of the first connecting line L18 is connected between the holding solenoid valve 26b and the FL cylinder 27c, that is, the downstream side of the holding solenoid valve 26b within the second system 26. Thus, the first changeover valve 25d is connected to both the hydraulic line L11 connected to the master cylinder 22 and the hydraulic line L22 connected to the FL cylinder 27c, and allows or interrupts fluid communication between the hydraulic line L11 and the hydraulic line L22. That is, the first changeover valve 25d allows or interrupts connection between the master cut solenoid valve 25a of the first system 25 and the FL cylinder 27c. The second changeover valve 26d is provided in the second connecting line L28, and handles the RL cylinder 27b. In the first embodiment, one end of the second connecting line L28 is connected to the upstream side of the holding solenoid valve 26b and holding solenoid valve 26c within the second system 26, that is, the hydraulic line L21. In addition, the other end of the second connecting line L28 is connected between the holding solenoid valve 25c and the RL cylinder 27b, that is, the downstream side of the holding solenoid valve 25c within the first system 25. That is, the other end of the second connecting line L28 is connected between the RL cylinder 27b and the holding solenoid Valve 25c. The RL cylinder 27b is provided for the left rear wheel that is opposite the FL cylinder 27c in the longitudinal direction of the vehicle CA. The FL cylinder 27c is provided for the left front wheel (not shown) to which the first connecting line L18 is connected. Thus, the second changeover valve 26d is connected to both the hydraulic line L21 connected to the master cylinder 22 and the hydraulic line L13 connected to the RL cylinder 27b, and allows or interrupts fluid communication between the hydraulic line L21 and the hydraulic line L13. That is, the second changeover valve 26d allows or interrupts connection between the master cut solenoid valve 26a of the second system 26 and the RL cylinder 27b. The above changeover valves 25d and 26d are normally closed solenoid valves and are connected to the brake controller 28. Thus, each of the changeover valves 25d and 26d is controlled for opening and closing so that the on/off state of each of the changeover valves 25d and 26d is controlled by the valve open/close control unit 28i of the brake controller 28. Each of the changeover valves 25d and 26d is energized when it is turned on by the brake controller 28, and is fully open when energized. On the other hand, each of the changeover valves 25d and 26d is de-energized when it is turned off by the brake controller 28, and is fully closed when de-energized.

The pressure reducing solenoid valve 25e handles the FR cylinder 27a. The pressure reducing solenoid valve 25e is connected to both the hydraulic line L12 connected to the FR cylinder 27a and the hydraulic line L14 connected to the reservoir 25g. The pressure reducing solenoid valve 25e allows or interrupts fluid communication between the hydraulic line L12 and the hydraulic line L14. That is, the pressure reducing solenoid valve 25e allows or interrupts connection between the FR cylinder 27a and the reservoir 25g. In addition, the pressure reducing solenoid valve 25f handles the RL cylinder 27b. The pressure reducing solenoid valve 25f is connected to both the hydraulic line L13 connected to the RL cylinder 27b and the hydraulic line L14 connected to the reservoir 25g. The pressure reducing solenoid valve 25f allows or interrupts fluid communication between the hydraulic line L13 and the hydraulic line L14. That is, the pressure reducing solenoid valve 25f allows or interrupts connection between the RL cylinder 27b and the reservoir 25g. In addition, the pressure reducing solenoid valve 26e handles the FL cylinder 27c. The pressure reducing solenoid valve 26e is connected to both the hydraulic line L22 connected to the FL cylinder 27c and the hydraulic line L24 connected to the reservoir 26g. The pressure reducing solenoid valve 26e allows or interrupts fluid communication between the hydraulic line L22 and the hydraulic line L24. That is, the pressure reducing solenoid valve 26e allows or interrupts connection between the FL cylinder 27c and the reservoir 26g. In addition, the pressure reducing solenoid valve 26f handles the RR cylinder 27d. The pressure reducing solenoid valve 26f is connected to both the hydraulic line L23 connected to the RR cylinder 27d and the hydraulic line L24 connected to the reservoir 26g. The pressure reducing solenoid valve 26f allows or interrupts fluid communication between the hydraulic line L23 and the hydraulic line L24. That is, the pressure reducing solenoid valve 26f allows or interrupts connection between the RR cylinder 27d and the reservoir 26g. Each of the pressure reducing solenoid valves 25e, 25f, 26e and 26f is a normally closed solenoid valve, and is connected to the brake controller 28. Thus, each of the pressure reducing solenoid valves 25e, 25f, 26e and 26f is controlled for opening and closing so that the on/off state of each of the pressure reducing solenoid valves 25e, 25f, 26e and 26f is controlled, by the valve open/close control unit 28i of the brake controller 28. Each of the pressure reducing solenoid valves 25e, 25f, 26e and 26f is energized when it is turned on by the brake controller 28, and is fully open when energized. On the other hand, when each of the pressure reducing solenoid valves 25e, 25f, 26e and 26f is de-energized when it is turned off by the brake controller 28, and is fully closed when de-energized.

The reservoir 25g is connected to the hydraulic line L15 connected to both the hydraulic line L14 and the pressure pump 25h, and is also connected to the hydraulic line L17 connected to the hydraulic line L10 via the check valve 25k. Thus, the brake fluid OIL1 from the pressure reducing solenoid valves 25e and 25f or the brake fluid OIL1 in the hydraulic line L10, that is, in the upstream side of the master cut solenoid valve 25a, may be introduced into the reservoir 25g. The reservoir 26g is connected to the hydraulic line L25 connected to both the hydraulic line L24 and the pressure pump 26h, and is also connected to the hydraulic line L27 connected to the hydraulic line L20 via the check valve 26k. Thus, the brake fluid OIL2 from the pressure reducing solenoid valves 26e and 26f or the brake fluid OIL2 in the hydraulic line L20, that is, in the upstream side of the master cut solenoid valve 26a, may be introduced into the reservoir 26g.

The pressure pumps 25h and 26h constitute the pressurizing unit, and respectively pressurize the brake fluids OIL1 and OIL2. The pressure pump 25h is connected to both the hydraulic line L15 connected to the reservoir 25g and the hydraulic line L16 connected to the hydraulic line L11 via the check valve 25i. Thus, the pressure pump 25h draws the brake fluid OIL1 in the upstream side of the master cut solenoid valve 25a via the reservoir 25g, pressurizes the drawn brake fluid OIL1, and then discharges the pressurized brake fluid OIL1 into the hydraulic line L11, that is, the downstream side of the master cut solenoid valve 25a. In addition, the pressure pump 26h is connected to both the hydraulic line L25 connected to the reservoir 26g and the hydraulic line L26 connected to the hydraulic line L21 via the check valve 25i. Thus, the pressure pump 26h draws the brake fluid OIL2 in the upstream side of the master cut solenoid valve 26a via the reservoir 26g, pressurizes the drawn brake fluid OIL2, and then discharges the pressurized brake fluid OIL2 into the hydraulic line L21, that is, the downstream side of the master cut solenoid valve 26a. Here, the pressure pumps 25h and 26h are driven by the actuator motor 29. The actuator motor 29 is connected to the brake controller 28. Thus, the pressure pumps 25h and 261i are driven as the actuator motor 29 is driven by the brake controller 28. As described above, the pressure pumps 25h and 26h respectively pressurize the brake fluids OIL1 and OIL2, and the master cut solenoid valves 25a and 26a respectively regulate differential pressures between the pressures of the pressurized brake fluids OIL1 and OIL2 and the master cylinder pressure PMC. In this manner, the pressurizing unit separately applies the applied pressure Pp1 in the first system 25 and the applied pressure Pp2 in the second system 26 respectively to the brake fluids OIL1 and OIL2. Thus, the pressure braking force based on the applied pressure Pp1 and the pressure braking force based on the applied pressure Pp2 are exerted on the vehicle CA as an applied braking force.

The right front wheel (not shown) of the vehicle CA includes the FR cylinder 27a, a brake pad 27e, and a brake rotor 27i. The left rear wheel of the vehicle CA includes the RL cylinder 27b, a brake pad 27f, and a brake rotor 27k. The left front wheel of the vehicle CA includes the FL cylinder 27c, a brake pad 27g, and a brake rotor 27l. The right rear wheel of the vehicle CA includes the RR cylinder 27d, a brake pad 27h, and a brake rotor 27m. Each of the wheel cylinders 27a to 27d generates a pressure braking force in such a manner that the resultant pressure of the wheel cylinder pressure PWC, which is the pressure of the filled brake fluid OIL, that is, the master cylinder pressure PMC, and the applied pressure Pp1 or the applied pressure Pp2 is exerted on a corresponding one of pairs of the brake pads 27e to 271i and the brake rotors 27i to 27m. As the wheel cylinder pressure PWC is exerted on each of the wheel cylinders 27a to 27d, each of the wheel cylinders 27a to 27d causes a corresponding one of the brake pad 27e to 27h to contact with the opposite one of the brake rotors 27i to 27m that integrally rotate with the respective wheels (not shown), thus generating a pressure braking force on the basis of frictional forces generated respectively between the brake pads 27e to 27h and the brake rotors 27i to 27m. Note that, when the same wheel cylinder pressure PWC is exerted on each of the wheel cylinders 27a to 27d, the brake pads 27e and 27g and the brake rotors 27i and 27l, provided for the front wheels, are configured to generate frictional forces larger than frictional forces generated respectively between the brake pads 27f and 27h and the brake rotors 27k and 27m, provided for the rear wheels.

The brake controller 28 (control unit) controls the braking system 1-1 to generate a braking force based on a driver's braking request. The brake controller 28 controls the pressure braking system 2. As shown in FIG. 1, the brake controller 28 receives various input signals from sensors provided for the braking system 1-1 and the vehicle CA. In the first embodiment, the input signals include a pedal stroke ST detected by the stroke sensor 21a, a negative pressure PV detected by the negative pressure sensor 23a, a master cylinder pressure PMC detected by the master cylinder pressure sensor 24.

The brake controller 28 outputs various output signals on the basis of these input signals and various maps prestored in a storage unit 28c. In the first embodiment, the output signals include signals for controlling the opening degrees of the master cut solenoid valves 25a and 26a, signals for controlling the on/off states of the holding solenoid valves 25b, 25c, 26b and 26c, signals for controlling the on/off states of the changeover valves 25d and 26d, signals for controlling the on/off states of the pressure reducing solenoid valves 25e, 25f, 26e and 26f, a signal for controlling the actuator motor 29 that drives the pressure pumps 25h and 26h, and the like.

In addition, the brake controller 28 is formed of an input/output unit (I/O) 28a that inputs the input signals and outputs the output signals, a processing unit 28b, and the storage unit 28c. The processing unit 28b is formed of a memory and a central processing unit (CPU). The processing unit 28b at least includes a required braking force setting unit 28d, a master pressure braking force setting unit 28e, a braking mode setting unit 28f, a front/rear distribution ratio setting unit 28g, an applied braking force setting unit 28h, the valve open/close control unit 28i, a pump drive control unit 28k, and an abnormality detecting unit 28l. The processing unit 29b may implement a method of controlling the braking system 1-1, particularly, a method of controlling the pressure braking system 2, or the like, by executing a program based on the method of controlling the braking system 1-1, or the like, loaded onto the memory.

In addition, the storage unit 28c prestores various maps, such as a BF*-ST-PMC map. Note that the storage unit 29c may be formed of a memory that allows only reading, such as a nonvolatile memory, like a flash memory, and a read only memory (ROM), a memory that allows both reading and writing, such as a random access memory (RAM), or a combination of them.

The BF*-ST-PMC map is based on a required braking force BF*, a pedal stroke ST and a master cylinder pressure PMC, and represents the correspondence relationship among a required braking force BF*, a pedal stroke ST and a master cylinder pressure PMC. In the BF*-ST-PMC map, an increased required braking force BF* is set as the pedal stroke ST and/or the master cylinder pressure PMC increase. Note that in the first embodiment, the required braking force BF* is set on the basis of the BF*-ST-PMC map, the detected pedal stroke ST and the detected master cylinder pressure PMC; however, the embodiments of the invention are not limited to it. For example, the required braking force BF* may be set on the basis of a BF*-ST-PMC-PV based on a required braking force BF*, a pedal stroke ST, a master cylinder pressure PMC and a negative pressure PV, the detected pedal stroke ST, the detected master cylinder pressure PMC and the negative pressure PV detected by the negative pressure sensor 23a. In the BF*-ST-PMC-PV map, the increased required braking force BF* is set as the negative pressure PV decreases at the same pedal stroke ST and the same master cylinder pressure PMC.

The required braking force setting unit 28d sets a required braking force based on a driver's braking request. The required braking force setting unit 28d basically sets a required braking force BF* on the basis of the master cylinder pressure PMC detected by the master cylinder pressure sensor 24 and the BF*-ST-PMC map. In addition, the required braking force setting unit 28d sets a required front wheel braking force BF*f and a required rear wheel braking force BF*r on the basis of the set required braking force BF* and the front/rear distribution ratio set by the front/rear distribution ratio setting unit 28g.

The master pressure braking force setting unit 28e sets a pressure braking force based on the operating pressure, that is, the master pressure braking force BFpmc, a front wheel master pressure braking force BFpmcf for the front wheels (not shown) of the vehicle CA, and a rear wheel master pressure braking force BFpmcr for the rear wheels of the vehicle CA on the basis of the master cylinder pressure PMC detected by the master cylinder pressure sensor 24.

The braking mode setting unit 28f sets the braking mode of the braking system 1-1. In the first embodiment, the braking mode setting unit 28f sets the braking mode of the braking system 1-1 to any one of a front/rear braking mode and a diagonal braking mode. The braking mode setting unit 28f switches the braking mode to the front/rear braking mode when no abnormality is detected by the abnormality detecting unit 28l, which will be described later, and switches the braking mode to the diagonal braking mode when an abnormality is detected by the abnormality detecting unit 28l. That is, the brake controller 28 is able to switch the braking mode of the braking system 1-1 between the front/rear braking mode and the diagonal braking mode. Here, in the front/rear braking mode, a braking force (including a master pressure braking force and an applied braking force) generated in the braking system 1-1 is distributed between a front wheel braking force and a rear wheel braking force on the basis of a front/rear distribution ratio, which is the ratio between a front wheel braking force exerted on the front wheels (not shown) of the vehicle CA and a rear wheel braking force exerted on the rear wheels (not shown) of the vehicle CA. In addition, in the diagonal braking mode, a braking force (including a master pressure braking force and an applied braking force) generated in the braking system 1-1 is exerted on the right front wheel and left rear wheel (not shown) of the vehicle CA by the first system 25 and is exerted on the left front wheel and right rear wheel (not shown) of the vehicle CA by the second system 26. Note that the braking mode setting unit 28f maintains one braking mode when braking is being performed by the braking system 1-1.

The front/rear distribution ratio setting unit 28g is a distribution ratio setting unit. The front/rear distribution ratio setting unit 28g sets a front/rear distribution ratio KF:KR, which is the ratio between a front wheel braking force and a rear wheel braking force, in the front/rear braking mode. In the first embodiment, the storage unit 28c prestores a front/rear distribution ratio KF0:KR0 based on specifications of the vehicle CA, and the like, and the front/rear distribution ratio setting unit 28g sets the stored front/rear distribution ratio KF0:KR0 for the front/rear distribution ratio KF:KR.

The applied braking force setting unit 28h sets a first applied braking force BFpp1 for the first system 25 and a second applied braking force BFpp2 for the second system 26 on the basis of a required braking force BF* set by the required braking force setting unit 29d and a master pressure braking force BFpmc set on the basis of the master cylinder pressure PMC detected by the master cylinder pressure sensor 24. In the first embodiment, the applied braking force setting unit 28h sets a first applied braking force BFpp1 and a second applied braking force BFpp2 on the basis of the set required braking force BF* and the set master pressure braking force BFpmc. In addition, the applied braking force setting unit 28h sets a first applied braking force BFpp1 and a second applied braking force BFpp2 on the basis of the set required front wheel braking force BF*f, the set required rear wheel braking force BF*r, the set front wheel master pressure braking force BFpmcf, the set rear wheel master pressure braking force BFpmcr, the front/rear distribution ratio KF:KR that is set by the front/rear distribution ratio setting unit 28g.

The valve open/close control unit 28i controls the opening degree of each of the master cut solenoid valves 25a and 26a, the on/off state of each of the holding solenoid valves 25b, 25c, 26b and 26c, the on/off state of each of the changeover valves 25d and 26d, and the on/off state of each of the pressure reducing solenoid valves 25e, 25f, 26e and 26f. The valve open/close control unit 28i sets command electric current values I1 and I2 on the basis of the applied pressures Pp1 and Pp2. The applied pressures Pp1 and Pp2 are respectively set on the basis of the applied braking forces BFpp1 and BFpp2 set by the applied braking force setting unit 28h. The valve open/close control unit 28i controls the opening degrees of the master cut solenoid valves 25a and 26a on the basis of the set command electric current values I1 and I2, respectively. That is, the brake controller 28 controls the opening and closing of each of the valves 25a to 25f and 26a to 26f of the pressure braking system 2.

The pump drive control unit 28k drives the actuator motor 29 to drive the pressure pumps 25h and 26h. That is, the brake controller 28 performs pressurizing control such that a first applied braking force BFpp1 and a second applied braking force BFpp2 are set on the basis of a required braking force BF* in accordance with driver's operation of the brake pedal 21, a first applied pressure Pp1 and a second pressure Po2 are respectively set on the basis of the set first applied braking force BFpp1 and the set second applied braking force BFpp2, and then brake fluids OIL1 and OIL2 are separately pressurized on the basis of the set first applied pressure Pp1 and the set second applied pressure Pp2 to separately apply the first applied pressure Pp1 and the second applied pressure Pp2 set for the brake fluids OIL1 and OIL2. That is, the brake controller 28 performs pressurizing control on the basis of the set front/rear distribution ratio KF:KR.

The abnormality detecting unit 28l detects an abnormality eat least any one of the first system 25 and the second system 26. That is, the abnormality detecting unit 28l detects an abnormality of the pressure braking system 2. In the first embodiment, the abnormality detecting unit 28l detects at least any one of the first system 25 and the second system 26 on the basis of, for example, the detected pedal stroke ST and the detected master cylinder pressure PMC.

Here, the basic operation of the pressure braking system 2 will be described. First, as shown in FIG. 3, when the braking mode is the front/rear braking mode, the brake controller 28 energizes the first changeover valve 25d and the second changeover valve 26d to open the valves 25d and 26d (on control), energizes one holding solenoid valve 25c, between the holding solenoid valves 25b and 25c of the first system 25, connected to the second connecting line L28 to close the valve 25c (on control) and does not energize the other holding solenoid valve 25b to allow the valve 25b to be open (off control), and energizes one holding solenoid valve 26b, between the holding solenoid valves 26b and 26c of the second system 26, connected to the first connecting line L18 to close the valve 26b (on control) and does not energize the other holding solenoid valve 25c to allow the valve 25c to be open (off control). Note that no pressure reducing solenoid valves 25e, 25f, 26e and 26f are energized but are allowed to be closed (off control). Thus, the brake fluid OIL1 in the first system 25 is supplied only to the FR cylinder, 27a and the FL cylinder 27c. In addition, the brake fluid OIL2 in the second system 26 is supplied only to the RL cylinder 27b and the RR cylinder 27d. That is, in the front/rear braking mode, the brake fluid OIL1 in the first system 25 is supplied to the wheel cylinders 27a and 27c provided for the front wheels (not shown) of the vehicle CA, and the brake fluid OIL2 in the second system 26 is supplied to the wheel cylinders 27b and 27d provided for the rear wheels (not shown) of the vehicle CA.

Here, in the front/rear braking mode, by the pressurizing unit, the first applied pressure Pp1 may be applied to the brake fluid OIL1, and the second applied pressure Pp2 may be applied to the brake fluid OIL2. For example, the opening degrees of the master cut solenoid valves 25a and 26a are controlled on the basis of the command electric current values I1 and I2 from the brake controller 28, the opening degrees decrease as compared with the opening degrees of the fully-open master cut solenoid valves 25a and 26a, and then the actuator motor 29 that drives the pressure pumps 25h and 26h is driven on the basis of a drive command value from the brake controller 28. In this case, the brake fluids OIL1 and OIL2 are respectively introduced from the upstream sides of the master cut solenoid valves 25a and 26a, that is, the hydraulic lines L10 and L20, into the reservoirs 25g and 26g. The brake fluid OIL1 introduced into the reservoir 25g is pressurized by the pressure pump 25h. The pressurized brake fluid OIL1 is supplied to the FR cylinder 27a via the hydraulic line L11, the holding solenoid valve 25b and the hydraulic line L12 and is also supplied to the FL cylinder 27c via the first changeover valve 25d and the hydraulic lines L18 and L22. Here, the master cut solenoid valve 25a regulates a differential pressure between the brake fluid OIL1 in the downstream side of the master cut solenoid valve 25a, that is, the wheel cylinder pressure PWC exerted on the FR cylinder 27a and the FL cylinder 27c, and the brake fluid OIL1 in the upstream side of the master cut solenoid valve 25a, that is, the master cylinder pressure PMC generated by the master cylinder 22, as the first applied. pressure Pp1. Thus, the wheel cylinder pressure PWC exerted on the FR cylinder 27a and the FL cylinder 27c is the resultant pressure of the master cylinder pressure PMC and the first applied pressure Pp1. In addition, the brake fluid OIL2 introduced into the reservoir 26g is pressurized by the pressure pump 26h. The pressurized brake fluid OIL2 is supplied to the RR cylinder 27d via the hydraulic line L21, the holding solenoid valve 26c and the hydraulic line L23, and is also supplied to the RL cylinder 27b via the second changeover valve 26d and the hydraulic lines L28 and L13. Here, the master cut solenoid valve 26a regulates a differential pressure between the brake fluid OIL2 in the downstream side of the master cut solenoid valve 26a; that is, the wheel cylinder pressure PWC exerted on the RR cylinder 27d and the RL cylinder 27b, and the brake fluid OIL2 in the upstream side of the master cut solenoid valve 26a, that is, the master cylinder pressure PMC generated by the master cylinder 22, as the second applied pressure Pp2. Thus, the wheel cylinder pressure PWC exerted on the RR cylinder 27d and the RL cylinder 27b is the resultant pressure of the master cylinder pressure PMC and the second applied pressure Pp2. That is, the resultant pressures are respectively exerted on the wheel cylinders 27a to 27d as the wheel cylinder pressures PWC. Thus, the first applied pressure Pp1 applied to the brake fluid OIL1 is exerted on the FR cylinder 27a and the FL cylinder 27c, and the second applied pressure Pp2 applied to the brake fluid OIL2 is exerted on the RL cylinder 27b and the RR cylinder 27d. By so doing, the braking system 1-1 according to the first embodiment is able to selectively exert a front wheel braking force and a rear wheel braking force to the vehicle CA by separately controlling the first applied pressure Pp1 and the second applied pressure Pp2. Thus, it is possible to selectively change the front/rear distribution ratio KF:KR.

Next, as shown in FIG. 2, when the braking mode is the diagonal braking mode, the brake controller 28 does not energize the first changeover valve 25d or the second changeover valve 26d to allow the valves 25d and 26d to be closed (off control), does not energize the holding solenoid valves 25b and 25c of the first system 25 to allow the valves 25b and 25c to be open (off control), and does not energize the holding solenoid valves 26b and 26c of the second system 26 to allow the valves 26b and 26c to be open (off control). Note that no pressure reducing solenoid valves 25e, 25f, 26e and 26f are energized but are allowed to be closed (off control). Thus, the brake fluid OIL1 in the first system 25 is supplied only to the FR cylinder 27a and the RL cylinder 27b. In addition, the brake fluid OIL2 in the second system 26 is supplied only to the FL cylinder 27c and the RR cylinder 27d. That is, in the diagonal braking mode, the brake fluid OIL1 in the first system 25 is supplied to the wheel cylinders 27a and 27b provided respectively for the right front wheel and left rear wheel (not shown) of the vehicle CA, and the brake fluid OIL2 in the second system 26 is supplied to the wheel cylinders 27c and 27d provided respectively for the right front wheel and left rear wheel (not shown) of the vehicle CA.

Here, in the diagonal braking mode as well, by the pressurizing unit, the first applied pressure Pp1 may be applied to the brake fluid OIL1 and the second applied pressure Pp2 may be applied to the brake fluid OIL2. As described above, the brake fluid OIL1 introduced into the reservoir 25g is pressurized by the pressure pump 25h. The pressurized brake fluid is supplied to the FR cylinder 27a via the hydraulic line L11, the holding solenoid valve 25b and the hydraulic line L12, and is also supplied to the RL cylinder 27b via the holding solenoid valve 25c and the hydraulic line L13. As described above, a differential pressure between the wheel cylinder pressure PWC, exerted on the FR cylinder 27a and the RL cylinder 27b, and the master cylinder pressure PMC is regulated as the first applied pressure Pp1. Thus, the wheel cylinder pressure PWC exerted on the FR cylinder 27a and the RL cylinder 27b is the resultant pressure of the master cylinder pressure PMC and the first applied pressure Pp1. In addition, the brake fluid OIL2 introduced into the reservoir 26g is pressurized by the pressure pump 26h. The pressurized brake fluid OIL2 is supplied to the FL cylinder 27c via the hydraulic line L21, the holding solenoid valve 26b and the hydraulic line L22, and is also supplied to the RR cylinder 27d via the holding solenoid valve 26c and the hydraulic line L23. As described above, a differential pressure between the wheel cylinder pressure PWC, exerted on the FL cylinder 27c and the RR cylinder 27d, and the master cylinder pressure PMC is regulated as the second applied pressure Pp2. Thus, the wheel cylinder pressure PWC exerted on the FL cylinder 27c and the RR cylinder 27d is the resultant pressure of the master cylinder pressure PMC and the second applied pressure Pp2. Thus, the first applied pressure Pp1 applied to the brake fluid OIL1 is exerted on the FR cylinder 27a and the RL cylinder 27b, and the second applied pressure Pp2 applied to the brake fluid OIL2 is exerted on the FL cylinder 27c and the RR cylinder 27d. By so doing, even when any one of the first system 25 and the second system 26 has an abnormality, a front wheel braking force and a rear wheel braking force may be respectively exerted on a set of the diagonally opposite wheels (not shown) of the vehicle CA by any one of the systems.

Note that in the front/rear braking mode and the diagonal braking mode, when the first system 25 and the second system 26 are in a holding mode, the brake controller 28 does not energize the master cut solenoid valve 25a or 26a to allow the valves 25a and 26a to be open (off control), does not energize the first changeover valve 25d or the second changeover valve 26d to allow the valves 25d and 26d to be closed (off control), energizes the holding solenoid valves 25b, 25c, 26b and 26c to close the valves 25b, 25c, 26b and 26c (on control), does not energize the pressure reducing solenoid valve 25e, 25f, 26e or 26f to allow the valves 25e, 25f, 26e and 26f to be closed (off control), and does not drive the actuator motor 29 and does not pressurize the brake fluid OIL1 or OIL2 using the pressure pump 25h or 26h. In the holding mode, the brake fluids OIL1 and OIL2 are held between the changeover valves 25d and 26d and the holding solenoid valves 25b, 25c, 26b and 26c, and the wheel cylinders 27a to 27d. Thus, it is possible to maintain the wheel cylinder pressures PWC exerted respectively on the wheel cylinders 27a to 27d at constant. In addition, in the front/rear braking mode and the diagonal braking mode, when the first system 25 and the second system 26 are in a pressure reducing mode, the brake controller 28 does not energize the master cut solenoid valve 25a or 26a to allow the valves 25a and 26a to be open (off control), does not energize the first changeover valve 25d or the second changeover valve 26d to allow the valves 25d and 26d to be closed (off control), energizes the holding solenoid valves 25b, 25c, 26b and 26c to close the valves 25b, 25c, 26b and 26c (on control), energizes the pressure reducing solenoid valves 25e, 25f, 26e and 26f to open the valves 25e, 25f, 26e and 26f (on control), and does not drive the actuator motor 29 and does not pressurize the brake fluid OIL1 or OIL2 by the pressure pump 25h or 26h. In the pressure reducing mode, the brake fluids OIL1 and OIL2 held between the changeover valves 25d and 26d and the holding solenoid valves 25b, 25c, 26b and 26c, and the wheel cylinders 27a to 27d are stored in the reservoirs 25g and 26g via the hydraulic lines L14 and L24. Thus, it is possible to reduce the wheel cylinder pressures PWC exerted respectively on the wheel cylinders 27a to 27d. By so doing, the brake controller 28 is able to perform anti-lock brake control to prevents any one of the wheels (not shown) of the vehicle CA from locking to slip on a road surface.

In addition, even when the driver does not operate the brake pedal 21, the pressurizing unit is able to pressurize a brake fluid by the brake controller 28. At this time, when the brake controller 28 controls the valves 25a to 25f and 26a to 26f so as to attain the above described holding mode or pressure reducing mode, the wheel cylinder pressures PWC exerted on the wheel cylinders 27a to 27d may be adjusted. By so doing, the pressure braking system 2 is able to perform traction control such that, when any one of the wheels (not shown) of the vehicle CA is transmitting a driving force to a road surface, a slip on a road surface is suppressed, or the pressure braking system 2 is able to perform vehicle stability control (VS C) such that, while the vehicle CA is cornering, a side slip of any one of the front and rear wheels is suppressed.

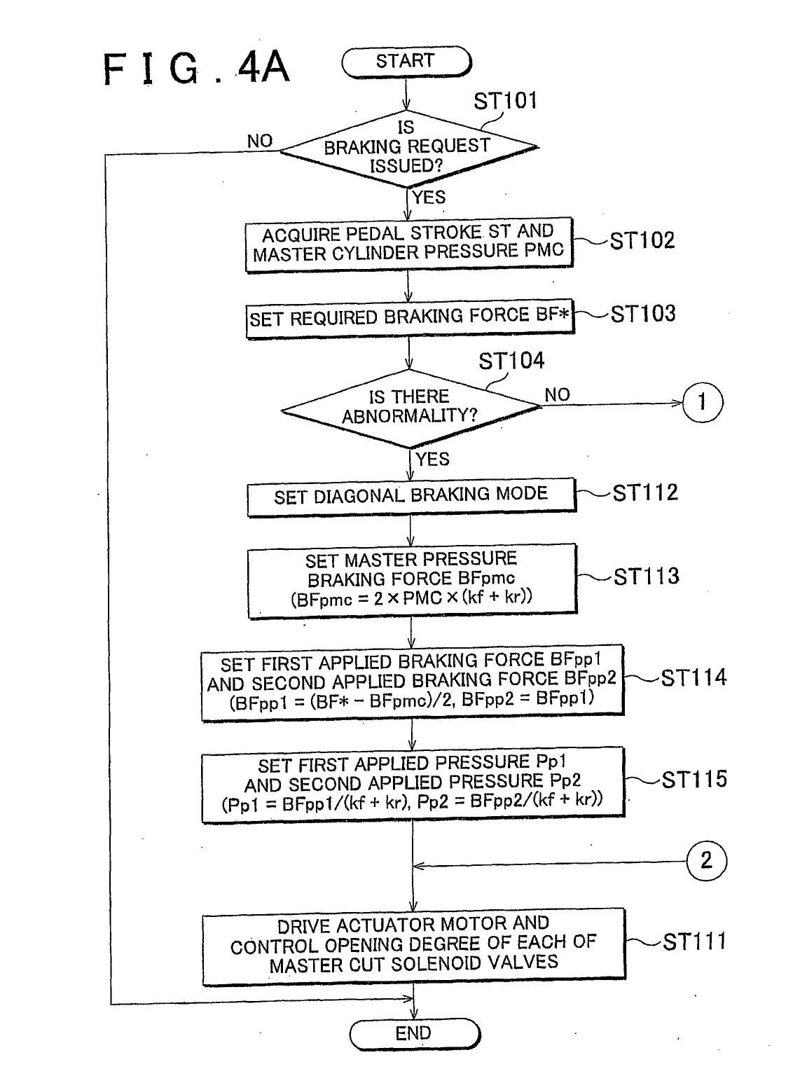

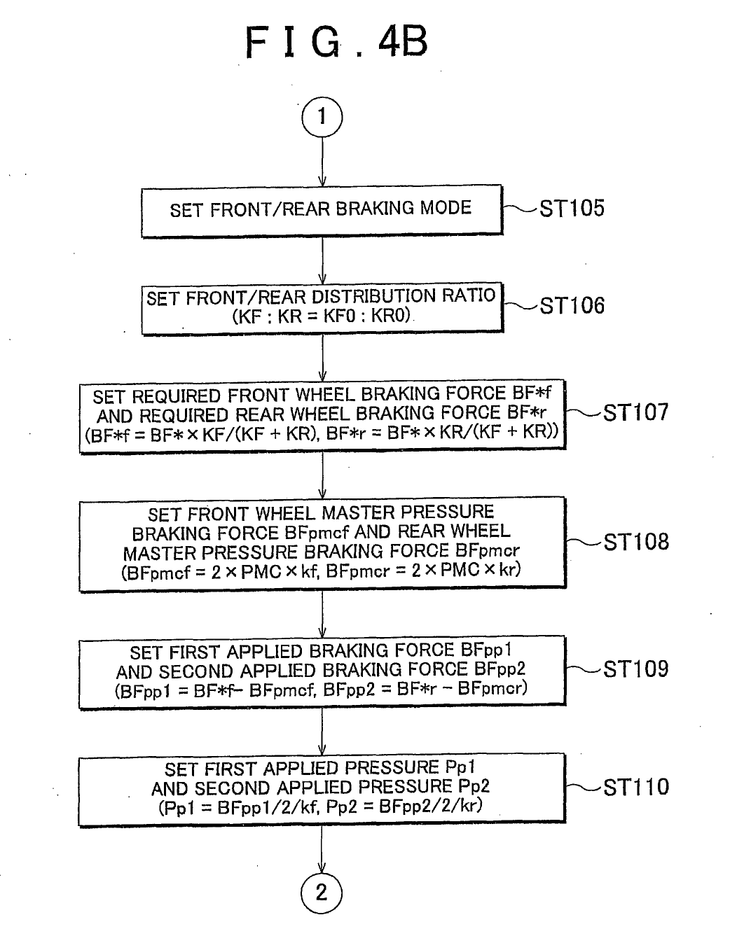

Next, a method of controlling the braking system 1-1 according to the first embodiment, particularly, a method of controlling a braking force generated by the braking system 1-1 will be described. FIG. 4A and FIG. 4B is a flowchart of a method of controlling the braking system according to the first embodiment. Note that the method of controlling the braking system 1-1 is executed at an interval of control of the braking system 1-1, for example, at an interval of several milliseconds.

First, as shown in the drawing, the processing unit 28b of the brake controller 28 determines whether a driver's braking request is issued (step ST101). Here, the processing unit 28b detects, for example, using a depression force detection sensor (not shown) that detects depression of the brake pedal 21, whether the brake pedal 21 is depressed by the driver to thereby determine whether a driver's braking request is issued.

Subsequently, when the processing unit 28b determines that the driver's braking request is issued (affirmative determination in step ST101), the processing unit 28b acquires the pedal stroke ST and the master cylinder pressure PMC (step ST102). Here, the processing unit 28b acquires the pedal stroke ST detected by the stroke sensor 21a and output to the brake controller 28, and acquires the master cylinder pressure PMC, which is the operating pressure, detected by the master cylinder pressure sensor 24 and output to the brake controller 28.

After that, the required braking force setting unit 28d of the processing unit 28b sets the required braking force BF* (step ST103). Here, in the first embodiment, the required braking force setting unit 28d sets the required braking force BF* in accordance with the driver's braking request on the basis of the detected pedal stroke ST, the detected master cylinder pressure PMC and the BF*-ST-PMC map.

Then, the abnormality detecting unit 28l of the processing unit 28b determines whether at least any one of the first system 25 and the second system 26 has an abnormality (step ST104).

Subsequently, when it is determined that neither the first system 25 nor the second system 26 has an abnormality (negative determination in step ST104), the braking mode setting unit 28f of the processing unit 28b sets the braking mode to the front/rear braking mode (step ST105). Here, as the braking mode is set to the front/rear braking mode, the valve open/close control unit 28i of the processing unit 28b opens the first changeover valve 25d and the second changeover valve 26d, closes the holding solenoid valve 25c and the holding solenoid valve 26b, opens the holding solenoid valve 25b and the holding solenoid valve 26c, and closes the pressure reducing solenoid valves 25e, 25f, 26e and 26f.

After that, the front/rear distribution ratio setting unit 28g of the processing unit 28b sets the front/rear distribution ratio KF:KR (step ST106). In the first embodiment, the front/rear distribution ratio KF0:KR0 stored in the storage unit 28c is set for the front/rear distribution ratio KF:KR (KF:KR=KF0:KR0).

Then, the required braking force setting unit 28d sets the required front wheel braking force BF*f and the required rear wheel braking force BF*r (step ST107). Here, the required braking force setting unit 28d sets the required front wheel braking force BF*f and the required rear wheel braking force BF*r on the basis of the set required braking force BF* and the following mathematical expressions (1) and (2).

BF*f=BF*×KF/(KF+KR) (1)

BF*r=BF*×KR/(KF+KR) (2)

Subsequently, the master pressure braking force setting unit 28e of the processing unit 28b sets the front wheel master pressure braking force BFpmcf and the rear wheel master pressure braking force BFpmcr on the basis of the master cylinder pressure PMC (step ST108). Here, the master pressure braking force setting unit 28e sets the front wheel master pressure braking force BFpmcf and the rear wheel master pressure braking force BFpmcr on the basis of the detected master cylinder pressure PMC and the following mathematical expressions (3) and (4). Here, kf is a conversion coefficient for deriving the braking forces of the FR cylinder 27a and FL cylinder 27c from the wheel cylinder pressures PWC exerted on the FR cylinder 27a and the FL cylinder 27c for the front wheels (not shown) of the vehicle CA. Here, kr is a conversion coefficient for deriving the braking forces of the RL cylinder 27b and RR cylinder 27d from the wheel cylinder pressures PWC exerted on the RL cylinder 27b and the RR cylinder 27d for the rear wheels (not shown) of the vehicle CA.

BFpmcf=2×PMC×kf (3)

BFpmcr=2×PMC×kr (4)

Then, the applied braking force setting unit 28h of the processing unit 28b sets the first applied braking force BFpp1 and the second applied braking force BFpp2 (step ST109). Here, the applied braking force setting unit 28h sets the first applied braking force BFpp1 on the basis of the set required front wheel braking force BF*f, the set front wheel master pressure braking force BFpmcf and the following mathematical expression (5), and sets the applied braking force BFpp2 on the basis of the set required rear wheel braking force BF*r, the set rear wheel master pressure braking force BFpmcr and the following mathematical expression (6).

BFpp1=BF*f−BFpmcf (5)

BFpp2=BF*r−BFpmcr (6)

After that, the processing unit 28b sets the first applied pressure Pp1 and the second applied pressure Pp2 (step ST110). Here, the processing unit 28b sets the first applied pressure Pp1 applied to the brake fluid OIL1 by the master cut solenoid valve 25a and the pressure pump 251i on the basis of the set first applied braking force BFpp1 and the following mathematical expression (7), and sets the second applied pressure Pp2 applied to the brake fluid OIL2 by the master cut solenoid valve 26a and the pressure pump 26h on the basis of the set second applied braking force BFpp2 and the following mathematical expression (8).

Pp1=BFpp1/2/kf (7)

Pp2=BFpp2/2/kr (8)

Subsequently, the pump drive control unit 28k of the processing unit 28b drives the actuator motor 29 to drive the pressure pumps 25h and 26h, and the valve open/close control unit 28i controls the opening degree of each of the master cut solenoid valves 25a and 26a (step ST111). Here, the pump drive control unit 28k drives each of the pressure pumps 25h and 26h constantly at a predetermined rotational speed so as to maintain a constant discharge rate. That is, the pump drive control unit 28k drives the actuator motor 29 for driving the pressure pumps 25h and 26h so that each of the pressure pumps 25h and 26h is driven constantly at a predetermined rotational speed so as to maintain a constant discharge rate. The valve open/close control unit 28i sets the command electric current value I1 for controlling the opening degree of the master cut solenoid valve 25a on the basis of the set first applied pressure Pp1 and a Pp1 map (not shown), and sets the command electric current value I2 for controlling the opening degree of the master cut solenoid valve 26a on the basis of the set second applied pressure Pp2 and the Pp-I map (not shown). The valve open/close control unit 28i controls the opening degree of each of the master cut solenoid valves 25a and 26a on the basis of a corresponding one of the set command electric current values I1 and I2. The pressure pump 25h is driven so as to maintain a constant discharge rate, and the opening degree of the master cut solenoid valve 25a is controlled. By so doing, the wheel cylinder pressure PWC exerted on the FR cylinder 27a and the FL cylinder 27c in the downstream side of the master cut solenoid valve 25a is the sum of the master cylinder pressure PMC in the upstream side of the master cut solenoid valve 25a and the first applied pressure Pp1 (differential pressure). That is, the wheel cylinder pressure PWC exerted on the FR cylinder 27a and the FL cylinder 27c is the resultant pressure of the master cylinder pressure PMC and the first applied pressure Pp1. Thus, the pressure braking force exerted on the FR cylinder 27a and the FL cylinder 27c is the resultant of the front wheel master pressure braking force BFpmcf based on the master cylinder pressure PMC and the first applied braking force BFpp1 based on the first applied pressure Pp1. The pressure pump 26h is driven so as to maintain a constant discharge rate, and the opening degree of the master cut solenoid valve 26a is controlled. By so doing, the wheel Cylinder pressure PWC exerted on the RL cylinder 27b and the RR cylinder 27d in the downstream side of the master cut solenoid valve 26a is the sum of the master cylinder pressure PMC in the upstream side of the master cut solenoid valve 26a and the second applied pressure Pp2 (differential pressure). That is, the wheel cylinder pressure PWC exerted on the RL cylinder 27b and the RR cylinder 27d is the resultant pressure of the master cylinder pressure PMC and the second applied pressure Pp2. Thus, the pressure braking force exerted on the RL cylinder 27b and the RR cylinder 27d is the resultant of the rear wheel master pressure braking force BFpmcr based on the master cylinder pressure PMC and the second applied braking force BFpp2 based on the second applied pressure Pp2.

In addition, when it is determined that at least any one of the first system 25 and the second system 26 has an abnormality (affirmative determination in step ST104), the braking mode setting unit 28f of the processing unit 28b sets the braking mode to the diagonal braking mode (step ST112). Here, as the braking mode is set to the diagonal braking mode, the valve open/close control unit 28i of the processing unit 28b closes the first changeover valve 25d and the second changeover valve 26d, opens the holding solenoid valves 25b, 25c, 26b and 26c, and closes the pressure reducing solenoid valves 25e, 25f, 26e and 26f.

Subsequently, the master pressure braking force setting unit 28e sets the master pressure braking force BFpmc on the basis of the master cylinder pressure PMC (step ST113). Here, the master pressure braking force setting unit 28e sets the master pressure braking force BFpmc exerted on all the wheels of the vehicle CA on the basis of the detected master cylinder pressure PMC and the following mathematical expression (9).

BFpmc=2×PMC×(kf+kr) (9)

After that, the applied braking force setting unit 28h of the processing unit 28b sets the first applied braking force BFpp1 and the second applied braking force BFpp2 (step ST114). Here, the applied braking force setting unit 28h sets the first applied braking force BFpp1 and the second applied braking force BFpp2 on the basis of the set required braking force BF*, the set master pressure braking force BFpmc and the following mathematical expressions (10) and (11). That is, in the diagonal braking mode, the same applied braking force is exerted on all the wheels (not shown) of the vehicle CA.

BFpp1=(BF*−BFpmc)/2 (10)

BFpp2=BFpp1 (11)

Then, the processing unit 28b sets the first applied pressure Pp1 and the second applied pressure Pp2 (step ST115). Here, the processing unit 28b sets the first applied pressure Pp1 applied to the brake fluid OIL1 by the master cut solenoid valve 25a and the pressure pump 25h on the basis of the set first applied braking force BFpp1 and the following mathematical expression (12), and sets the second applied pressure Pp2 applied to the brake fluid OIL2 by the master cut solenoid valve 26a and the pressure pump 26h on the basis of the set second applied braking force BFpp2 and the following mathematical expression (13). That is, in the diagonal braking mode, the same applied pressure is applied to each of the brake fluids OIL1 and OIL2.

Pp1=BFpp1/(kf+kr) (12)

Pp2=BFpp2/(kf+kr)=Pp1 (13)

Subsequently, as described above, the pump drive control unit 28k drives the actuator motor 29 to drive the pressure pumps 25h and 26h, and the valve open/close control unit 28i controls the opening degree of each of the master cut solenoid valves 25a and 26a (step ST111). The valve open/close control unit 28i controls the opening degree of each of the master cut solenoid valves 25a and 26a on the basis of a corresponding one of the set command electric current values I1 and I2. The pressure pump 25h is driven so as to maintain a constant discharge rate, and the opening degree of the master cut solenoid valve 25a is controlled. By so doing, the wheel cylinder pressure PWC exerted on the FR cylinder 27a and the RL cylinder 27b in the downstream side of the master cut solenoid valve 25a is the sum, of the master cylinder pressure PMC in the upstream side of the master cut solenoid valve 25a and the first applied pressure Pp1 (differential pressure). That is, the wheel cylinder pressure PWC exerted on the FR cylinder 27a and the RL cylinder 27b is the resultant pressure of the master cylinder pressure PMC and the first applied pressure Pp1. Thus, the pressure braking force exerted on the FR cylinder 27a and the RL cylinder 27b is the resultant of the front wheel master pressure braking force BFpmcf based on the master cylinder pressure PMC and the first applied braking force BFpp1 based on the first applied pressure Pp1. The pressure pump 26h is driven so as to maintain a constant discharge rate, and the opening degree of the master cut solenoid valve 26a is controlled. By so doing, the wheel cylinder pressure PWC exerted on the FL cylinder 27c and the RR cylinder 27d in the downstream side of the master cut solenoid valve 26a is the sum of the master cylinder pressure PMC in the upstream side of the master cut solenoid valve 26a and the second applied pressure Pp2 (differential pressure). That is, the wheel cylinder pressure PWC exerted on the FL cylinder 27c and the RR cylinder 27d is the resultant pressure of the master cylinder pressure PMC and the second applied pressure Pp2. Thus, the pressure braking force exerted on the FL cylinder 27c and the RR cylinder 27d is the resultant of the rear wheel master pressure braking force BFpmcr based on the master cylinder pressure PMC and the second applied braking force BFpp2 based on the second applied pressure Pp2.

As described above, in the front/rear braking mode, the braking system 1-1 according to the first embodiment is able to exert a front wheel braking force on the front wheels (not shown) of the vehicle CA using the first system 25, and is able to exert a rear wheel braking force on the rear wheels (not shown) of the vehicle CA using the second system 26. In addition, in the diagonal braking mode, the braking system 1-1 is able to exert a braking force on a set of the diagonally opposite wheels (not shown) of the vehicle CA using the first system 25, and is able to exert a braking force on the other diagonally opposite wheels (not shown, and wheels different from the wheels on which a braking force is exerted through the first system 25) of the vehicle CA using the second system 26. Thus, the braking system 1-1 is able to exert a braking force on a set of the diagonally opposite wheels of the vehicle CA, and is also able to distribute a braking force between a front braking force and a rear braking force. In addition, when the abnormality detecting unit 28l detects an abnormality, the braking system 1-1 switches the braking mode to the diagonal braking mode to exert a braking force on a set of the diagonally opposite wheels of the vehicle using any one of the first system 25 and the second system 26, that is, does not exert a braking force only on the front wheels, rear wheels, left wheels or right wheels of the vehicle CA. Thus, it is possible to maintain stability of the behavior of the vehicle in the event of an abnormality.

### Second Embodiment

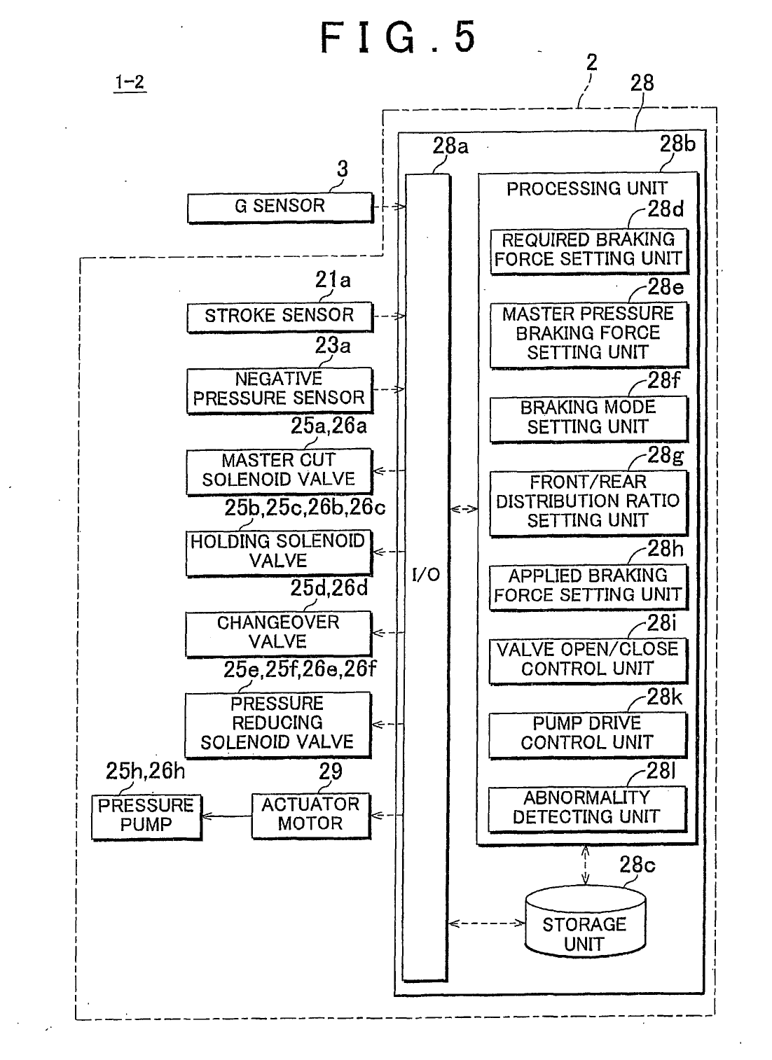

FIG. 5 is a view that shows a schematic configuration example of a braking system according to a second embodiment. The second embodiment differs from the first embodiment in that the front/rear distribution ratio KF KR is set on the basis of a load shift in accordance with an attitude change of the vehicle CA at the time of braking. The braking system 1-2 according to the second embodiment includes a pressure braking system 2 and a G sensor 3. Note that the basic configuration of the braking system 1-2 according to the second embodiment is similar to the basic configuration of the braking system 1-1 according to the first embodiment, so the description thereof is omitted.

As shown in FIG. 5, the G sensor 3 is an acceleration detecting unit, and detects an acceleration of the vehicle CA. In the second embodiment, the G sensor 3 is attached to the position of the center of gravity of the vehicle CA, and is connected to the brake controller 28. An acceleration G detected by the G sensor 3, particularly, an deceleration at the time of braking, is output to the brake controller 28. Note that the storage unit 28c of the brake controller 28 prestores the height H of the center of gravity and wheel base L of the vehicle CA.

In the second embodiment, the front/rear distribution ratio setting unit 28g of the brake controller 28 sets the front/rear distribution ratio KF:KR on the basis of the detected acceleration G Here, the front/rear distribution ratio setting unit 28g sets the front/rear distribution ratio KF:KR on the basis of a load shift amount X and the front/rear distribution ratio KF0:KR0 prestored in the storage unit 28c. The load shift amount X is determined for the front wheels and the rear wheels (not shown) of the vehicle CA on the basis of the detected acceleration G, the height H of the center of gravity and the wheel base L that are prestored in the storage unit 28c. That is, the front/rear distribution ratio setting unit 28g sets the dynamic front/rear distribution ratio KF:KR in consideration of a load shift at the time of braking of the vehicle CA. Note that in the second embodiment, the front/rear distribution ratio KF0:KR0 stored in the storage unit 28c is based on a load ratio, which is the ratio between a front wheel load and a rear wheel load of the vehicle CA when the vehicle CA is standing still.

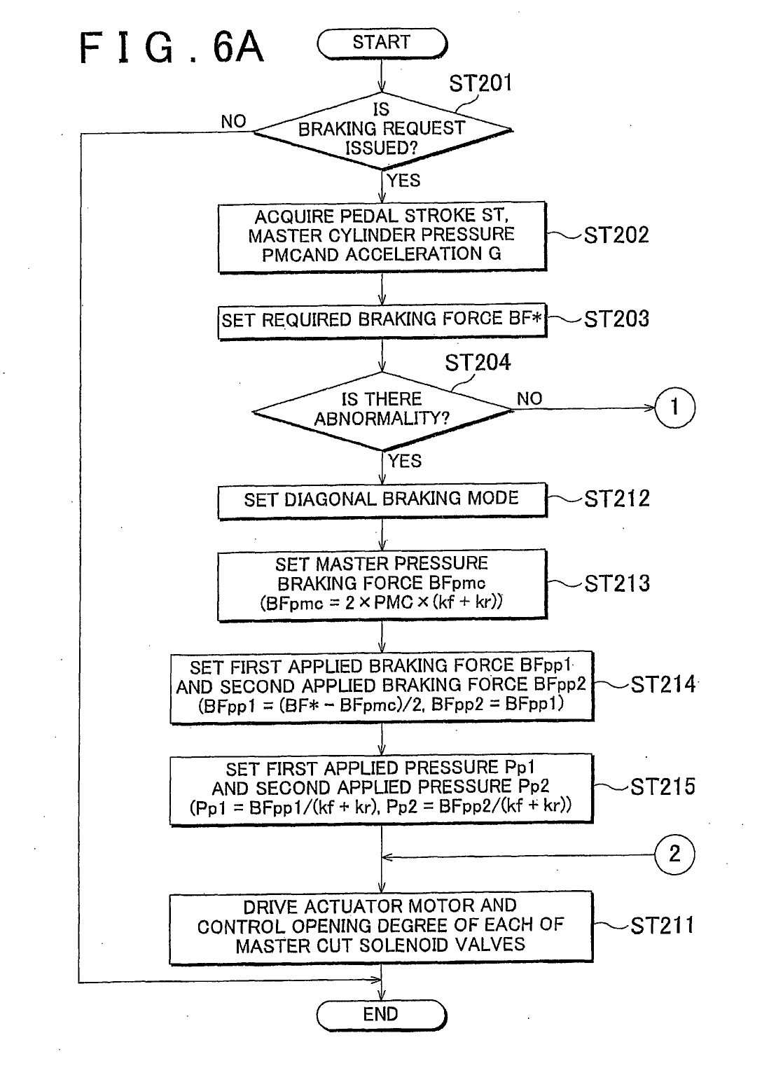

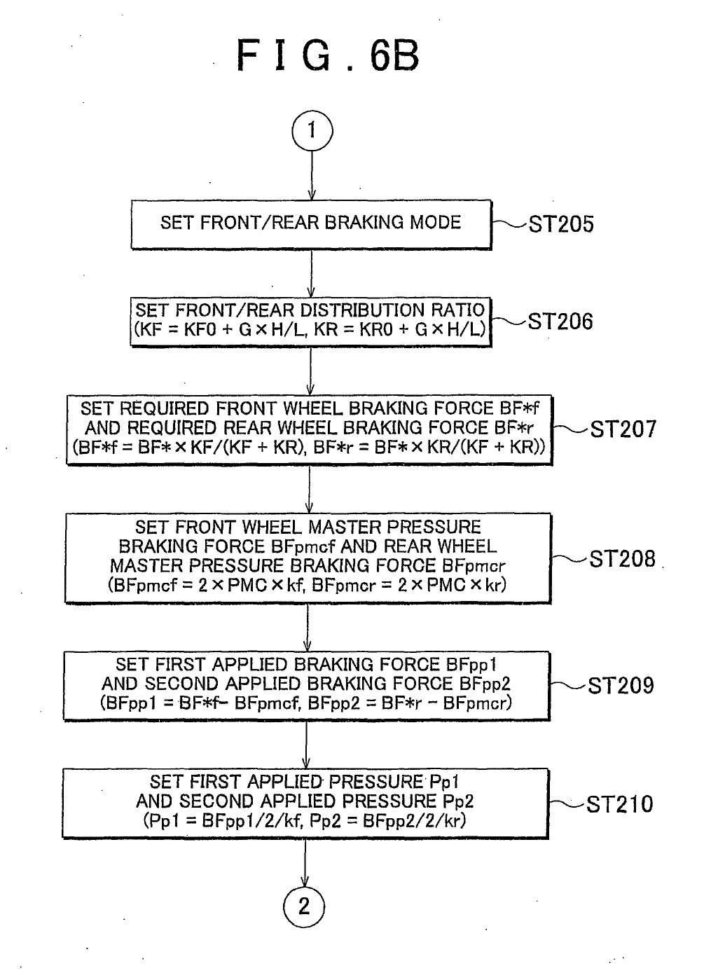

Next, a method of controlling the braking system 1-2 according to the second embodiment, particularly, a method of controlling a braking force generated by the braking system 1-2 will be described. FIG. 6A and FIG. 6B is a flowchart of a method of controlling the braking system according to the second embodiment. Note that the method of controlling the braking system 1-2 according to the second embodiment has a similar basic procedure to the method of controlling the braking system 1-1 according to the first embodiment, so the description thereof is simplified or omitted.

First, as shown in the drawing, the processing unit 28b determines whether a driver's braking request is issued (step ST201).

Subsequently, when the processing unit 28b determines that the driver's braking request is issued (affirmative determination in step ST201), the processing unit 28b acquires the pedal stroke ST, the master cylinder pressure PMC and the acceleration G (step ST202). Here, the processing unit 28b acquires the pedal stroke ST detected by the stroke sensor 21a and output to the brake controller 28, acquires the master cylinder pressure PMC, which is the operating pressure, detected by the master cylinder pressure sensor 24 and output to the brake controller 28, and acquires the acceleration G detected by the G sensor 3 and output to the brake controller 28, that is, the deceleration in this case because the driver's braking request is issued and the braking system 1-2 is braking the vehicle CA.

After that, the required braking force setting unit 28d sets the required braking force BF* (step ST203).

Then, the abnormality detecting unit 28l determines whether at least any one of the first system 25 and the second system 26 has an abnormality (step ST204).

Subsequently, when it is determined that neither the first system 25 nor the second system 26 has an abnormality (negative determination in step ST204), the braking mode setting unit 28f sets the braking mode to the front/rear braking mode (step ST205).

After that, the front/rear distribution ratio setting unit 28g sets the front/rear distribution ratio KF:KR (step ST206). In the second embodiment, the front/rear distribution ratio KF:KR is set on the basis of the detected acceleration G, the height H of the center of gravity, the wheel base L and the front/rear distribution ratio KF0:KR0 that are stored in the storage unit 28c, and the following mathematical expressions (14) and (15).

KF=KF0+G×H/L (14)

KR=KR0−G×H/L (15)

Then, the required braking force setting unit 28d sets the required front wheel braking force BF*f and the required rear wheel braking force BF*r on the basis of the front/rear distribution ratio KF:KR (step ST207).

Subsequently, the master pressure braking force setting unit 28e sets the front wheel master pressure braking force BFpmcf and the rear wheel master pressure braking force BFpmcr on the basis of the master cylinder pressure PMC (step ST208).

Then, the applied braking force setting unit 28h sets the first applied braking force BFpp1 and the second applied braking force BFpp2 (step ST209).

After that, the processing unit 28b sets the first applied pressure Pp1 and the second applied pressure Pp2 (step ST210).

Subsequently, the pump drive control unit 28k of the processing unit 28b drives the actuator motor 29 to drive the pressure pumps 25h and 26h, and the valve open/close control unit 28i controls the opening degree of each of the master cut solenoid valves 25a and 26a (step ST211). Thus, in the front/rear barking mode, on the basis of the front/rear distribution ratio KF:KR, the front wheel braking force is exerted on the front wheels (not shown) of the vehicle CA, and the rear wheel braking force is exerted on the rear wheels (not shown) of the vehicle CA.

In addition, when it is determined that at least any one of the first system 25 and the second system 26 has an abnormality (affirmative determination in step ST204), the braking mode setting unit 28f of the processing unit 28b sets the braking mode to the diagonal braking mode (step ST212).

Subsequently, the master pressure braking force setting unit 28e sets the master pressure braking force BFpmc on the basis of the master cylinder pressure PMC (step ST213).

Then, the applied braking force setting unit 28h sets the first applied braking force BFpp1 and the second applied braking force BFpp2 (step ST214).

After that, the processing unit 28b sets the first applied pressure Pp1 and the second applied pressure Pp2 (step ST215).

Subsequently, the pump drive control unit 28k drives the actuator motor 29 to drive the pressure pumps 25h and 26h, and the valve open/close control unit 28i controls the opening degree of each of the master cut solenoid valves 25a and 26a (step ST211).

As described above, the braking system 1-2 according to the second embodiment, as well as the first embodiment, is able to exert a braking force on a set of the diagonally opposite wheels of the vehicle CA, and is also able to distribute a braking force between a front braking force and a rear braking force. In addition, it is possible to maintain stability of the behavior of the vehicle in the event of an abnormality. In addition, distribution of the braking force between a front wheel braking force and a rear wheel braking force is set on the basis of the detected acceleration G of the vehicle CA. Thus, even when the braking force is exerted on the vehicle CA and, as a result, a front wheel load on the front wheels (not shown) of the vehicle CA and a rear wheel load on the rear wheels of the vehicle CA shift from the front wheel load and the rear wheel load when the vehicle CA is standing still, it is possible to distribute the braking force between a front wheel braking force and a rear wheel braking force in consideration of the load shift. Thus, it is possible to improve stability of the behavior of the vehicle at the time of braking.

### Third Embodiment

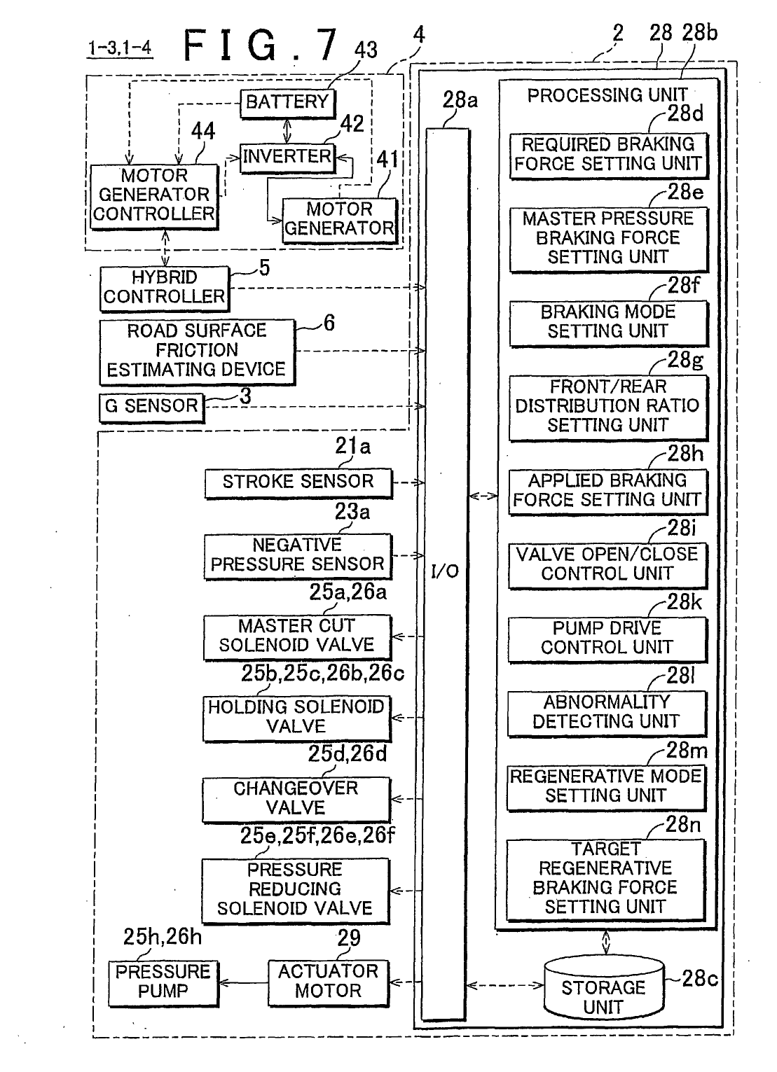

FIG. 7 is a view that shows a schematic configuration example of a braking system according to third and fourth embodiments. The third embodiment differs from the first embodiment in that a regenerative braking system 4 is further provided. That is, the difference is that the vehicle CA is a hybrid vehicle. A braking system 1-3 according to the third embodiment includes a pressure braking system 2, a G sensor 3, the regenerative braking system 4 (regenerative braking unit), a hybrid controller 5, and a road surface friction estimating device 6. Note that the basic configuration of the braking system 1-3 according to the third embodiment is similar to the basic configuration of the braking system 1-1 according to the first embodiment, so the description thereof is omitted.

A regenerative mode setting unit 28m of the processing unit 28b sets a regenerative mode of the regenerative braking system 4. When the braking mode is the front/rear braking mode, the regenerative mode setting unit 28m sets the regenerative Mode to any one of a distribution priority mode or a fuel economy priority mode. In the third embodiment, the regenerative mode setting unit 28m switches the regenerative mode between the distribution priority mode and the fuel economy priority mode on the basis of the acceleration G detected by the G sensor 3 and output to the brake controller 28 and a road surface friction coefficient μ estimated by the road surface friction estimating device 6, which will be described later. That is, the regenerative mode is switched on the basis of the state of deceleration of the vehicle CA and the frictional condition of a road surface on which the vehicle CA runs. Specifically, the regenerative mode setting unit 28m switches the regenerative mode to the distribution priority mode when the detected acceleration G is smaller than or equal to a predetermined acceleration (when the deceleration is larger than or equal to a predetermined deceleration), and when the estimated road surface friction coefficient μ is lower than or equal to a predetermined road surface friction coefficient. Here, the distribution priority mode is a regenerative mode in which distribution of the braking force between a front wheel braking force and a rear wheel braking force based on the front/rear distribution ratio has priority over regenerative braking. In addition, the fuel economy priority mode is a regenerative mode in which regenerative braking has priority over distribution of the braking force between a front wheel braking force and a rear wheel braking force based on the front/rear distribution ratio. Note that the regenerative mode setting unit 28m may switch the regenerative mode between the distribution priority mode and the fuel economy priority mode on the basis of any one of the detected acceleration G and the estimated road surface friction coefficient μ.

A target regenerative braking force setting unit 28n of the processing unit 28b is a regenerative braking force setting unit. The target regenerative braking force setting unit 28n sets a difference between the required braking force BF* (the required front wheel braking force BF*f and the required rear wheel braking force BF*r) set by the required braking force setting unit 28d and the pressure braking force based on the operating pressure, that is, the master pressure braking force BFpmc (the front wheel master pressure braking force BFpmcf and the rear wheel master pressure braking force BFpmcr) as a target regenerative braking force BFr*. In the third embodiment, the target regenerative braking force setting unit 28n sets the target regenerative braking force BFr* as a value obtained by subtracting the front wheel master pressure braking force BFpmcf from the required front wheel braking force BF*f in the distribution priority mode, and sets the target regenerative braking force BFr* as a value obtained by subtracting the master pressure braking force BFpmc from the required braking force BF* in the fuel economy priority mode. Thus, the target regenerative braking force BFr* in the fuel economy priority mode may add a value, which is obtained by subtracting the rear wheel master pressure braking force BFpmcr from the required rear wheel braking force BF*r, to the target regenerative braking force BFr* in the distribution priority mode. Thus, the target regenerative braking force setting unit 28n is able to set the target regenerative braking force BFr* so that the target regenerative braking force BFr* is larger when the regenerative mode is the fuel economy priority mode than when the regenerative mode is the distribution priority mode. That is, the target regenerative braking force setting unit 28n changes the target regenerative braking force BFr* on the basis of any one of the detected acceleration G and the estimated road surface friction coefficient μ.

As shown in FIG. 7, the regenerative braking system 4 is a regenerative braking unit. The regenerative braking system 4 generates a regenerative braking force to perform regenerative braking. In the third embodiment, the regenerative braking system 4 exerts a regenerative braking force on the front wheels (not shown) of the vehicle CA. The regenerative braking system 4 generates a regenerative braking force on the basis of the target regenerative braking force BFr* set by the target regenerative braking force setting unit 28n. The regenerative braking system 4 basically generates a difference between the required braking force BF* (the required front wheel braking force BF*f and the required rear wheel braking force BF*r) and the pressure braking force based on the operating pressure, that is, the master pressure braking force BFpmc (the front wheel master pressure braking force BFpmcf and the rear wheel master pressure braking force BFpmcr) as a regenerative braking force. In addition, the brake controller 28 performs pressurizing control when the sum of the master pressure braking force BFpmc (the front wheel master pressure braking force BFpmcf and the rear wheel master pressure braking force BFpmcr) and an effective regenerative braking force BTK, which is an actual regenerative braking force based on the set target regenerative braking force BFr*, is smaller than the set required braking force BF* (the required front wheel braking force BF*f and the required rear wheel braking force BF*r).

The regenerative braking system 4 includes a motor generator 41, an inverter 42, a battery 43, and a motor generator controller 44. The motor generator 41 operates as a generator and also operates as a motor. The motor generator 41 is, for example, a synchronous generator-motor. The motor generator 41 is coupled to an axle. When the motor generator 41 operates as a motor, the motor generator 41 applies a rotational force via the axle to the wheels mounted on the axle. When the motor generator 41 operates as a generator, the motor generator 41 generates a regenerative braking force on the axle on the basis of the rotational force of the wheels. The motor generator 41 is connected to the battery 43 via the inverter 42. The motor generator 41 rotates with electric power supplied from the battery 43 to be able to operate as a motor, while the motor generator 41 performs regenerative braking and stores generated electric power in the battery 43 to be able to operate as a generator. The motor generator 41 is connected to the motor generator controller 44. The motor generator controller 44 performs drive control for operating the motor generator 41 as a motor via the inverter 42 or performs regenerative braking control for operating the motor generator 41 as a generator via the inverter 42. The motor generator controller 44 is connected to the hybrid controller 5. The motor generator controller 44 performs switching control over the inverter 42 in accordance with an instruction for drive control from the hybrid controller 5 or an instruction for regenerative braking control based on the target regenerative braking force BFr*. Note that the hybrid controller 5 receives the rotational speed of the motor generator 41, the phase current values to the motor generator 41, and the like, via the motor generator controller 44. In addition, the battery 43 is connected to a battery controller (not shown), and is managed by the battery controller. The battery controller calculates a state of charge (SOC), input/output restriction, or the like, on the basis of a charging and discharging electric current, a battery temperature, or the like. The battery controller is connected to the hybrid controller 5, and the state of charge SOC, or the like, is output to the hybrid controller 5.

The hybrid controller 5 totally controls operations of the vehicle CA. The hybrid controller 5 is connected to the brake controller 28, the motor generator controller 44, an engine controller that controls operations of the internal combustion engine (not shown), the battery controller (not shown), a transmission controller that controls a transmission that transmits the driving force of the internal combustion engine to the wheels, and the like. Note that the hybrid controller 5 receives the on/off state of an ignition switch (not shown), the shift position of a shift lever (not, shown), the accelerator operation amount of an accelerator pedal (not shown), the vehicle speed of the vehicle CA, and the like, from sensors provided for the hybrid vehicle.

The road surface friction estimating device 6 estimates a road surface friction coefficient g that indicates the frictional condition of a road surface on which the vehicle CA runs. The road surface friction estimating device 6 is connected to the brake controller 28, and the road surface friction coefficient g detected by the road surface friction estimating device 6 is output to the brake controller 28. Note that a method for estimating the road surface friction coefficient g by the road surface friction estimating device 6 (for example, estimating the road surface friction coefficient μ on the basis of a slip ratio of a selected one of the wheels) is already a known technique, so the description thereof is omitted.

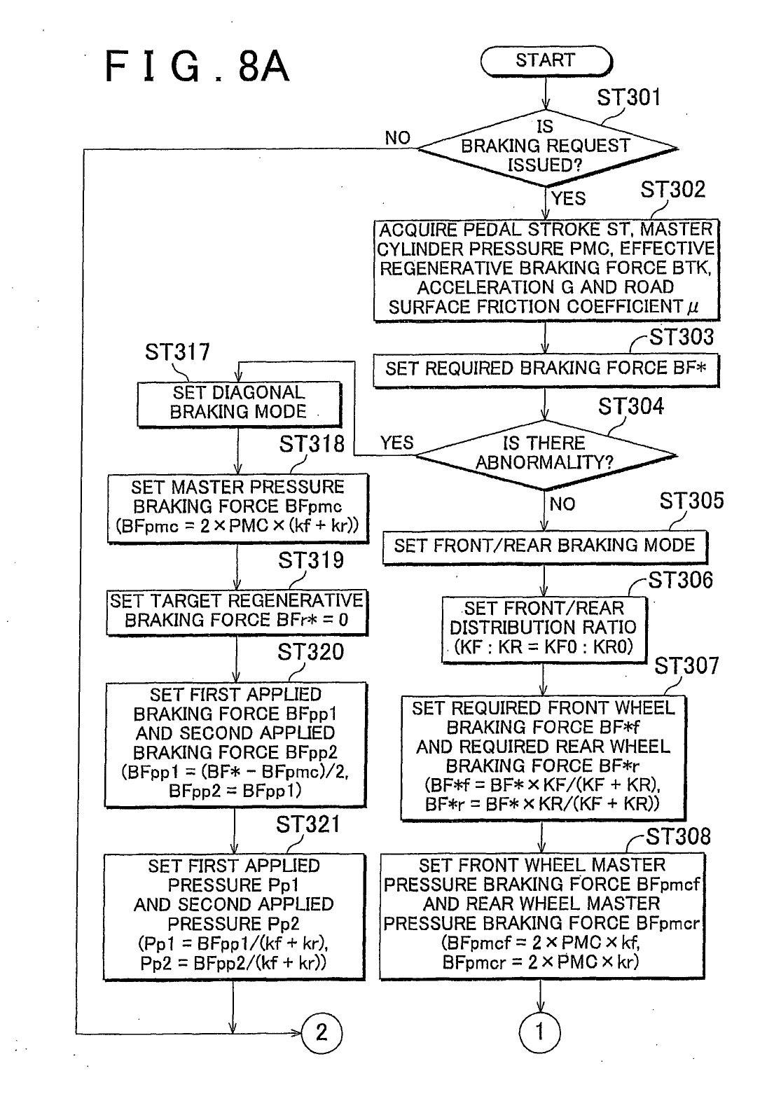

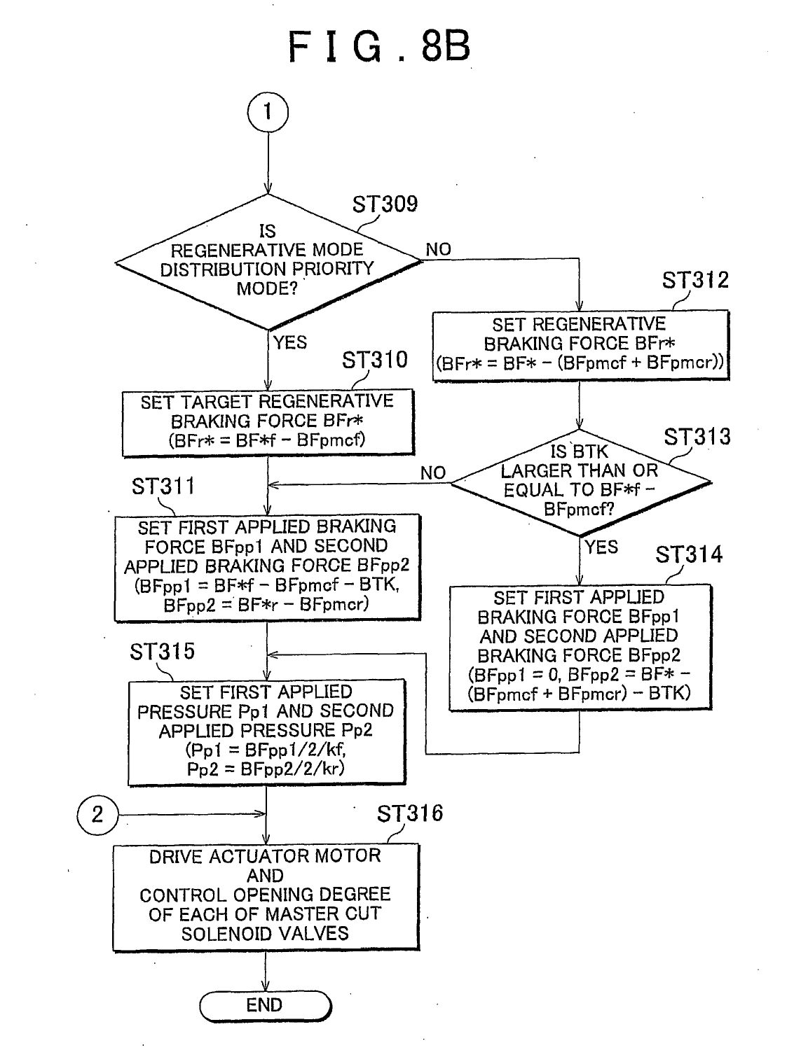

Next, a method of controlling the braking system 1-3 according to the third embodiment, particularly, a method of controlling a braking force generated by the braking system 1-3 will be described. FIG. 8A and FIG. 8B is a flowchart of a method of controlling the braking system according to the third embodiment. Note that the method of controlling the braking system 1-3 according to the third embodiment has a similar basic procedure to the method of controlling the braking system 1-1 according to the first embodiment, so the description thereof is simplified or omitted.

First, as shown in the drawing, the processing unit 28b determines whether a driver's braking request is issued (step ST301).

Subsequently, when the processing unit 28b determines that the driver's braking request is issued (affirmative determination in step ST301), the processing unit 28b acquires the pedal stroke ST, the master cylinder pressure PMC, the effective regenerative braking force BTK, the acceleration G and the road surface friction coefficient μ (step ST302). Here, the processing unit 28b acquires the pedal stroke ST detected by the stroke sensor 21a and output to the brake controller 28, acquires the master cylinder pressure PMC, which is the operating pressure, detected by the master cylinder pressure sensor 24 and output to the brake controller 28, acquires the effective regenerative braking force BTK output from the hybrid controller 5 to the brake controller 28, acquires the acceleration G detected by the G sensor 3 and output to the brake controller 28, that is, the deceleration in this case because the driver's braking request is issued and the braking system 1-3 is braking the vehicle CA, and acquires the road surface friction coefficient μ estimated by the road surface friction estimating device 6 and output to the brake controller 28. Note that the effective regenerative braking force BTK is a regenerative braking force that is set by the target regenerative braking force setting unit 28n and that can be actually generated by the regenerative braking system 4 on the basis of the target regenerative braking force BFr* output to the hybrid controller 5, the rotational speed of the motor generator 41, and the state of charge SOC of the battery 43. Thus, the effective regenerative braking force BTK is not based on the target regenerative braking force BFr* set in a current control period but based on the target regenerative braking force BFr* set previous time or before.

After that, the required braking force setting unit 28d sets the required braking force BF* (step ST303).

Then, the abnormality detecting unit 28l determines whether at least any one of the first system 25 and the second system 26 has an abnormality (step ST304).

Subsequently, when it is determined that neither the first system 25 nor the second system 26 has an abnormality (negative determination in step ST304), the braking mode setting unit 28f sets the braking mode to the front/rear braking mode (step ST305).

After that, the front/rear distribution ratio setting unit 28g sets the front/rear distribution ratio KF:KR (step ST306). In the third embodiment, the front/rear distribution ratio KF0:KR0 stored in the storage unit 28c is set for the front/rear distribution ratio KF:KR (KF:KR=KF0:KR0).

Then, the required braking force setting unit 28d sets the required front wheel braking force BF*f and the required rear wheel braking force BF*r on the basis of the front/rear distribution ratio KF:KR (step ST307).

Subsequently, the master pressure braking force setting unit 28e sets the front wheel master pressure braking force BFpmcf and the rear wheel master pressure braking force BFpmcr on the basis of the master cylinder pressure PMC (step ST308).

Next, the regenerative mode setting unit 28m of the processing unit 28b determines whether the regenerative mode is the distribution priority mode (step ST309). Here, the regenerative mode setting unit 28m determines whether the acquired acceleration G is smaller than or equal to a predetermined acceleration, and when the acquired road surface friction coefficient μ is lower than or equal to a predetermined road surface friction coefficient. That is, the regenerative mode setting unit 28m determines whether stability of the behavior of the vehicle CA at the time of braking is likely to decrease.

Then, when it is determined that the regenerative mode is the distribution priority mode (affirmative determination in step ST309), the target regenerative braking force setting unit 28n of the processing unit 28b sets the target regenerative braking force BFr* in the distribution priority mode (step ST310). Here, the target regenerative braking force setting unit 28n sets the target regenerative braking force BFr* in the distribution priority mode on the basis'of the set required front wheel braking force BF*f, the set front wheel master pressure braking force BFpmcf, and the following mathematical expression (16). That is, in the third embodiment, when the regenerative mode is the distribution priority mode, a regenerative braking force generated by the regenerative braking system 4 is exerted on the front wheels (not shown) of the vehicle . CA. Thus, the target regenerative braking force BFr* is set so that the sum of the pressure braking force exerted on the front wheels on the basis of the operating pressure and the regenerative braking force exerted on the front wheels by the regenerative braking system 4 coincides with the set required front wheel braking force BF*f.

BFr*=BF*f−BFpmcf (16)

Here, the target regenerative braking force setting unit 28n transmits the set target regenerative braking force BFr* to the hybrid controller 5. The hybrid controller 5 sets the effective regenerative braking force BTK that can be actually generated by the regenerative braking system 4 on the basis of the target regenerative braking force BFr*, the rotational speed of the motor generator 41, and the state of charge SOC of the battery 43, and then transmits the set effective regenerative braking force BTK to the motor generator controller 44. The motor generator controller 44 performs switching control over the inverter 42 on the basis of the effective regenerative braking force BTK to thereby perform regenerative braking control over the motor generator 41 on the basis of the effective regenerative braking force BTK. Thus, the effective regenerative braking force BTK is generated by the regenerative braking system 4.

After that, the applied braking force setting unit 28h sets the first applied braking force BFpp1 and the second applied braking force BFpp2 in the distribution priority mode (step ST311). Here, the applied braking force setting unit 28h sets the first applied braking force BFpp1 on the basis of the set required front wheel braking force BF*f, the set front wheel master pressure braking force BFpmcf, the acquired effective regenerative braking force BTK, and the following mathematical expression (17), and sets the second applied braking force BFpp2 on the basis of the set required rear wheel braking force BF*r, the set rear wheel master pressure braking force BFpmcr, and the following mathematical expression (18).

BFpp1=BF*f−BFpmcf−BTK (17)

BFpp2=BF*r−BFpmcr (18)

After that, the processing unit 28b sets the first applied pressure Pp1 and the second applied pressure Pp2 (step ST315).

Subsequently, the pump drive control unit 28k of the processing unit 28b drives the actuator motor 29 to drive the pressure pumps 25h and 26h, and the valve open/close control unit 28i controls the opening degree of each of the master cut solenoid valves 25a and 26a (step ST316). Thus, in the distribution priority mode, the front wheel braking force is exerted on the front wheels (not shown) of the vehicle CA and the rear wheel braking force is exerted on the rear wheels (not shown) of the vehicle CA on the basis of the front/rear distribution ratio KF:KR. By so doing, it is possible to distribute the braking force including regenerative braking force between a front wheel braking force and a rear wheel braking force while maintaining the front/rear distribution ratio KF:KR.

Then, when it is determined that the regenerative mode is the fuel economy priority mode (negative determination in step ST309), the target regenerative braking force setting unit 28n of the processing unit 28b sets the target regenerative braking force BFr* in the fuel economy priority mode (step ST312). Here, the target regenerative braking force setting unit 28n sets the target regenerative braking force BFr* in the fuel economy priority mode on the basis of the set required braking force BF*, the master pressure braking force BFpmcr, which is the sum of the set front wheel master pressure braking force BFpmcf and the set rear wheel master pressure braking force BFpmcr, and the following mathematical expression (19). That is, in the third embodiment, when the regenerative mode is the fuel economy priority mode, the target regenerative braking force BFr* is set so that the sum of the pressure braking force exerted on all the wheels (not shown) of the vehicle CA based on the operating pressure and the regenerative braking force exerted on the front wheels by the regenerative braking system 4 coincides with the set required braking force BF*. Note that as in the case of the step ST310, the motor generator controller 44 performs switching control over the inverter 42 on the basis of the effective regenerative braking force BTK to thereby perform regenerative braking control over the motor generator 41 on the basis of the effective regenerative braking force BTK. Thus, the effective regenerative braking force BTK is generated by the regenerative braking system 4.

BFr*=BF*−(BFpmcf+BFpmcr) (19)

Subsequently, the processing unit 28b determines whether the acquired effective regenerative braking force BTK is larger than or equal to a value obtained by subtracting the front wheel master pressure braking force BFpmcf from the set required front wheel braking force BF*f (step ST313). Here, the processing unit 28b determines whether the current effective regenerative braking force BTK exerted on the front wheels (not shown) of the vehicle CA by the regenerative braking system 4 is larger than or equal to an amount by which a braking force is smaller than the set required front wheel braking force BF*f(BTK≧BF*f−BFpmcf).

After that, when it is determined that the acquired effective regenerative braking force BTK is larger than or equal to a value obtained by subtracting the front wheel master pressure braking force BFpmcf from the set required front wheel braking force BF*f (affirmative determination in step ST313), the applied braking force setting unit 28h sets the first applied braking force BFpp1 and the second applied braking force BFpp2 in the fuel economy priority mode (step ST314). Here, the applied braking force setting unit 28h sets the first applied braking force BFpp1 at 0 so that the first applied braking force BFpp1 is not exerted on the front wheels (not shown) of the vehicle CA (see the following mathematical expression (20)), and sets the second applied braking force BFpp2 on the basis of the set required braking force BF*, the master pressure braking force BFpmcf, which is the sum of the set front wheel master pressure braking force BFpmcf and the set rear wheel master pressure braking force BFpmcr, the effective regenerative braking force BTK, and the following mathematical expression (21). That is, the applied braking force setting unit 28h sets the second applied braking force so that the sum of the master pressure braking force BFpmc, the effective regenerative braking force BTK and the applied braking force does not exceed the required braking force BF*.

BFpp1=0 (20)

BFpp2=BF*−(BFpmcf+BFpmcr)−BTK (21)

In addition, when it is determined that the acquired effective regenerative braking force BTK is smaller than a value obtained by subtracting the front wheel master pressure braking force BFpmcf from the set required front wheel braking force BF*f (negative determination in step ST313), the applied braking force setting unit 28h sets the first applied braking force BFpp1 and the second applied braking force BFpp2 in the fuel economy priority mode as in a similar manner to the distribution priority mode (step ST311). Here, the applied braking force setting unit 28h sets the first applied braking force BFpp1 on the basis of the set required front wheel braking force BF*f, the set front wheel master pressure braking force BFpmcf, the acquired effective regenerative braking force BTK, and the above mathematical expression (17), and sets the second applied braking force BFpp2 on the basis of the set required rear wheel braking force BF*r, the set rear wheel master pressure braking force BFpmcr, and the above mathematical expression (18).

After that, the processing unit 28b sets the first applied pressure Pp1 and the second applied pressure Pp2 (step ST315).

Subsequently, the pump drive control unit 28k of the processing unit 28b drives the actuator motor 29 to drive the pressure pumps 25h and 26h, and the valve open/close control unit 28i controls the opening degree of each of the master cut solenoid valves 25a and 26a (step ST316). Thus, in the fuel economy priority mode, the regenerative braking force generated by the regenerative braking system 4 is preferentially exerted on the front wheels (not shown) of the vehicle CA while maintaining the set required braking force BF*. By so doing, in the fuel economy priority mode, it is possible to distribute the braking force including the regenerative braking force between a front wheel braking force and a rear wheel braking force so that the front/rear distribution ratio is KF:KR, while making it possible to effectively perform regenerative braking by the regenerative braking system 4.

In addition, when it is determined that at least any one of the first system 25 and the second system 26 has an abnormality (affirmative determination in step ST304), the braking mode setting unit 28f of the processing unit 28b sets the braking mode to the diagonal braking mode (step ST317).

Subsequently, the master pressure braking force setting unit 28e sets the master pressure braking force BFpmc on the basis of the master cylinder pressure PMC (step ST318).

After that, the target regenerative braking force setting unit 28n sets the target regenerative braking three BFr* at 0 (step ST319). Here, the target regenerative braking force setting unit 28n sets the target regenerative braking force BFr* at 0 (BFr*=0) so that the regenerative braking system 4 does not perform regenerative braking in the diagonal braking mode.

Then, the applied braking force setting unit 28h sets the first applied braking force BFpp1 and the second applied braking force BFpp2 (step ST320).

After that, the processing unit 28b sets the first applied pressure Pp1 and the second applied pressure Pp2 (step ST321).

Subsequently, the pump drive control unit 28k of the processing unit 28b drives the actuator motor 29 to drive the pressure pumps 25h and 26h, and the valve open/close control unit 28i controls the opening degree of each of the master cut solenoid valves 25a and 26a (step ST316).

As described above, the braking system 1-3 according to the third embodiment, as well as the first embodiment, is able to exert a braking force on a set of the diagonally opposite wheels of the vehicle CA, and is also able to distribute a braking force including a regenerative braking force between a front braking force and a rear braking force. In addition, it is possible to maintain stability of the behavior of the vehicle in the event of an abnormality. When stability of the behavior of the vehicle CA at the time of braking is likely to decrease, the front/rear distribution ratio is maintained to distribute a braking force including a regenerative braking force between a front wheel braking force and a rear wheel braking force rather than regenerative braking performed by the regenerative braking unit. Thus, it is possible to suppress a decrease in stability.

### Fourth Embodiment

Next, a braking system according to a fourth embodiment will be described. The fourth embodiment differs from the third embodiment in that the front/rear distribution ratio KF:KR is set on the basis of a load shift in accordance with an attitude change of the vehicle CA at the time of braking. As shown in FIG. 7, a braking system 1-4 according to the fourth embodiment includes a pressure braking system 2, a G sensor 3, a regenerative braking system 4, a hybrid controller 5, and a road surface friction estimating device 6. Note that the basic configuration of the braking system 1-4 according to the fourth embodiment is similar to the basic configuration of the braking system 1-3 according to the third embodiment, so the description thereof is omitted. In addition, the function of the front/rear distribution ratio setting unit 28g of the braking system 1-4 according to the fourth embodiment is similar to the function of the front/rear distribution ratio setting unit 28g of the braking system 1-2 according to the second embodiment, so the description thereof is omitted.

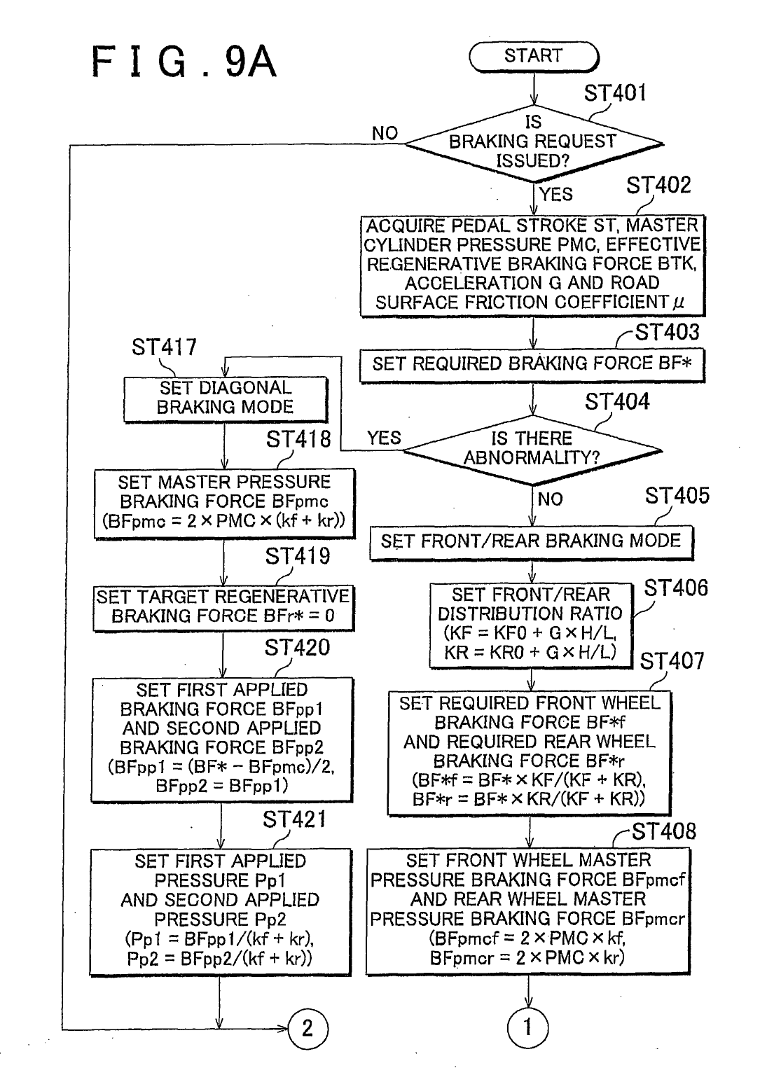

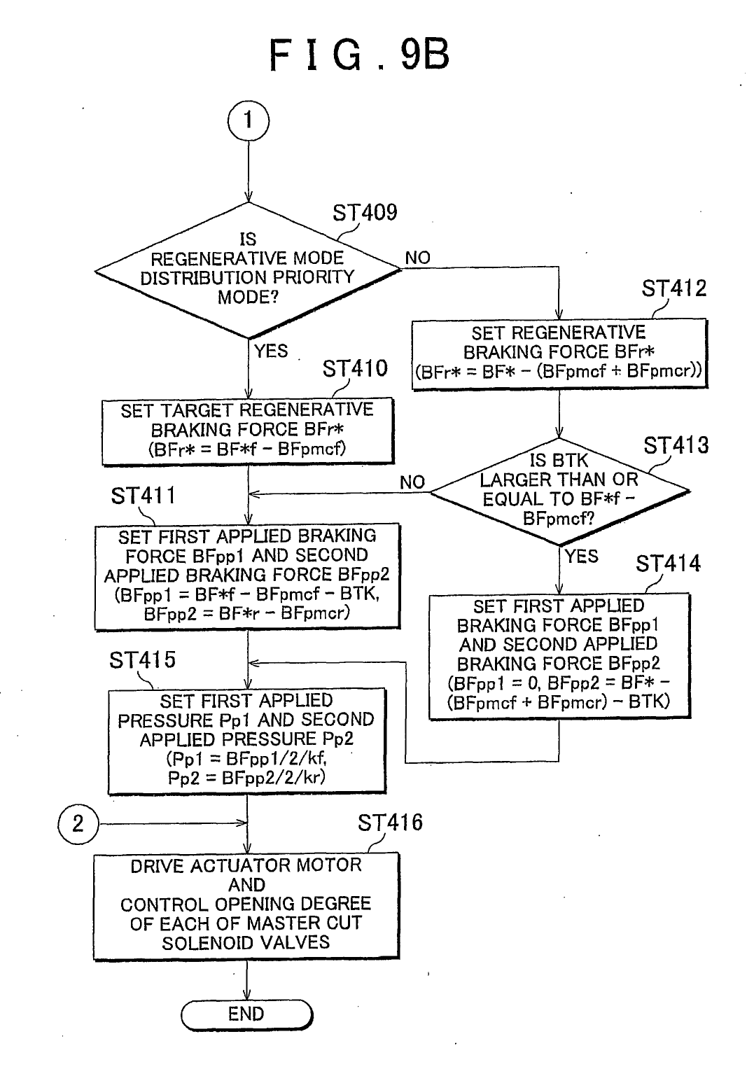

Next, a method of controlling the braking system 1-4 according to the fourth embodiment, particularly, a method of controlling a braking force generated by the braking system 1-4 will be described. FIG. 9A and FIG. 9B is a flowchart of a method of controlling the braking system according to the fourth embodiment. Note that the method of controlling the braking system 1-4 according to the fourth embodiment has a similar basic procedure to the method of controlling the braking system 1-3 according to the third embodiment, so the description thereof is simplified or omitted.

First, as shown in the drawing, the processing unit 28b determines whether a driver's braking request is issued (step ST401).

Subsequently, when the processing unit 28b determines that the driver's braking request is issued (affirmative determination in step ST401), the processing unit 28b acquires the pedal stroke ST, the master cylinder pressure PMC, the effective regenerative braking force BTK, the acceleration G and the road surface friction coefficient μ (step ST402).

After that, the required braking force setting unit 28d sets the required braking force BF* (step ST403).

Then, the abnormality detecting unit 28l determines whether at least any one of the first system 25 and the second system 26 has an abnormality (step ST404).

Subsequently, when it is determined that neither the first system 25 nor the second system 26 has an abnormality (negative determination in step ST404), the braking mode setting unit 28f sets the braking mode to the front/rear braking mode (step ST405),

After that, the front/rear distribution ratio setting unit 28g sets the front/rear distribution ratio KF:KR (step ST406). In the fourth embodiment, the front/rear distribution ratio KF:KR is set on the basis of the detected acceleration G, the height H of the center of gravity, the wheel base L and the front/rear distribution ratio KF0:KR0 that are stored in the storage unit 28c, and the above mathematical expressions (14) and (15).

Then, the required braking force setting unit 28d sets the required front wheel braking force BF*f and the required rear wheel braking force BF*r on the basis of the front/rear distribution ratio KF:KR (step ST407).

Subsequently, the master pressure braking force setting unit 28e sets the front wheel master pressure braking force BFpmcf and the rear wheel master pressure braking force BFpmcr on the basis of the master cylinder pressure PMC (step ST408).

Next, the regenerative mode setting unit 28m of the processing unit 28b determines whether the regenerative mode is the distribution priority mode (step ST409).

Then, when it is determined that the regenerative mode is the distribution priority mode (affirmative determination in step ST409), the target regenerative braking force setting unit 28n of the processing unit 28b sets the target regenerative braking force BFr* in the distribution priority mode (step ST410).

After that, the applied braking force setting unit 28h sets the first applied braking force BFpp1 and the second applied braking force BFpp2 in the distribution priority mode (step ST411).

After that, the processing unit 28b sets the first applied pressure Pp1 and the second applied pressure Pp2 (step ST415).

Subsequently, the pump drive control unit 28k of the processing unit 28b drives the actuator motor 29 to drive the pressure pumps 25h and 26h, and the valve open/close control unit 28i controls the opening degree of each of the master cut solenoid valves 25a and 26a (step ST416). Thus, in the distribution priority mode, the front wheel braking force is exerted on the front wheels (not shown) of the vehicle CA and the rear wheel braking force is exerted on the rear wheels (not shown) of the vehicle CA on the basis of the front/rear distribution ratio KF:KR. By so doing, it is possible to distribute the, braking force including a regenerative braking force between a front wheel braking force and a rear wheel braking force while maintaining the front/rear distribution ratio KF:KR.

Then, when it is determined that the regenerative mode is the fuel economy priority mode (negative determination in step ST409), the target regenerative braking force setting unit 28n of the processing unit 28b sets the target regenerative braking force BFr* in the fuel economy priority mode (step ST412).

Subsequently, the processing unit 28b determines whether the acquired effective regenerative braking force BTK is larger than or equal to a value obtained by subtracting the front wheel master pressure braking force BFpmcf from the set required front wheel braking force BF*f (step ST413).

After that, when it is determined that the acquired effective regenerative braking force BTK is larger than or equal to a value obtained by subtracting the front wheel master pressure braking force BFpmcf from the set required front wheel braking force BF*f (affirmative determination in step ST413), the applied braking force setting unit 28h sets the first applied braking force BFpp1 and the second applied braking force BFpp2 in the fuel economy priority mode (step ST414).

In addition, when it is determined that the acquired effective regenerative braking force BTK is smaller than a value obtained by subtracting the front wheel master pressure braking force BFpmcf from the set required front wheel braking force BF*f (negative determination in step ST413), the applied braking force setting unit 28h sets the first applied braking force BFpp1 and the second applied braking force BFpp2 in the fuel economy priority mode as in a similar manner to the distribution priority mode (step ST411).

After that, the processing unit 28b sets the first applied pressure Pp1 and the second applied pressure Pp2 (step ST415).

Subsequently, the pump drive control unit 28k of the processing unit 28b drives the actuator motor 29 to drive the pressure pumps 25h and 26h, and the valve open/close control unit 28i controls the opening degree of each of the master cut solenoid valves 25a and 26a (step ST416).

In addition, when it is determined that at least any one of the first system 25 and the second system 26 has an abnormality (affirmative determination in step ST404), the braking mode setting unit 28f of the processing unit 28b sets the braking mode to the diagonal braking mode (step ST417).

Subsequently, the master pressure braking force setting unit 28e sets the master pressure braking force BFpmc on the basis of the master cylinder pressure PMC (step ST418).

After that, the target regenerative braking force setting unit 28n sets the target regenerative braking force BFr* at 0 (step ST419).

Then, the applied braking force setting unit 28h sets the first applied braking force BFpp1 and the second applied braking force BFpp2 (step ST420).

After that, the processing unit 28b sets the first applied pressure Pp1 and the second applied pressure Pp2 (step ST421).

Subsequently, the pump drive control unit 28k of the processing unit 28b drives the actuator motor 29 to drive, the pressure pumps 25h and 26h, and the valve open/close control unit 28i controls the opening degree of each of the master cut solenoid valves 25a and 26a (step ST416).

As described above, the braking system 1-4 according to the fourth embodiment, as well as the third embodiment, is able to exert a braking force on a set of the diagonally opposite wheels of the vehicle CA, and is also able to distribute a braking force including a regenerative braking force between a front braking force and a rear braking force. In addition, it is possible to maintain stability of the behavior of the vehicle in the event of an abnormality. When stability of the behavior of the vehicle CA at the time of braking is likely to decrease, the front/rear distribution ratio is maintained to distribute the braking force including a regenerative braking force between a front wheel braking force and a rear wheel braking force rather than regenerative braking performed by the regenerative braking unit. Thus, it is possible to suppress a decrease in stability. In addition, distribution of the braking force between a front wheel braking force and a rear wheel braking force is set on the basis of the detected acceleration G of the vehicle CA. Thus, even when the braking force is exerted on the vehicle CA and, as a result, a front wheel load on the front wheels (not shown) of the vehicle CA and a rear wheel load on the rear wheels of the vehicle CA shift from the front wheel load and the rear wheel load when the vehicle CA is standing still, it is possible to distribute the braking force between a front wheel braking force and a rear wheel braking force in consideration of the load shift. Thus, it is possible to improve stability of the behavior of the vehicle at the time of braking.

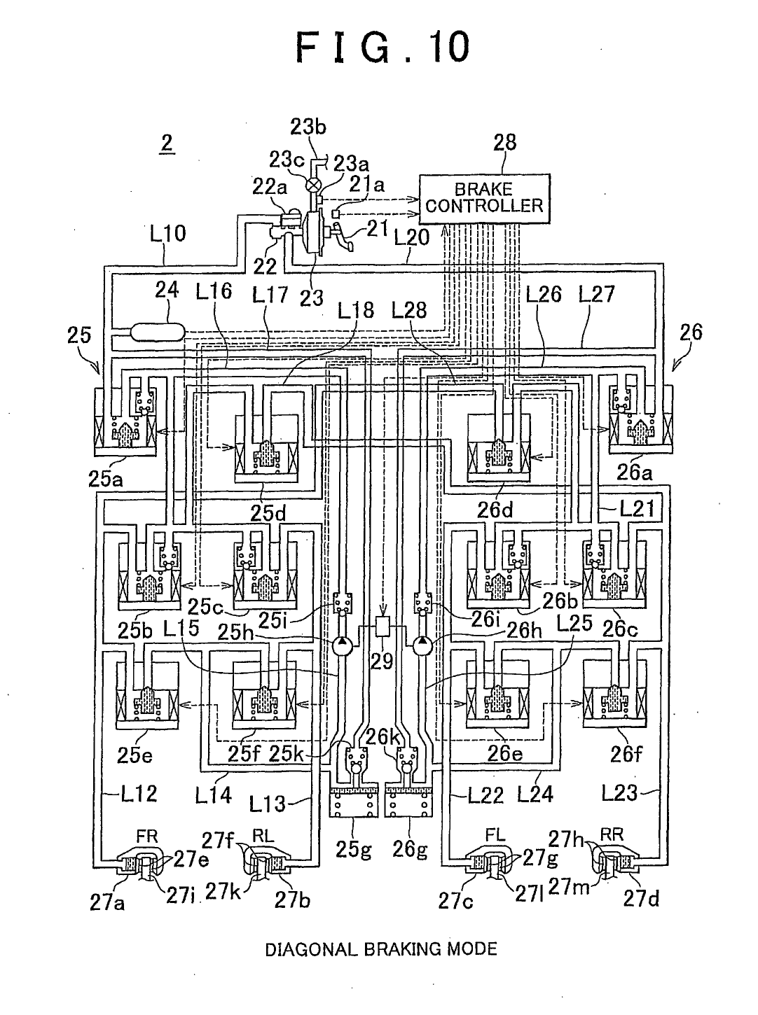

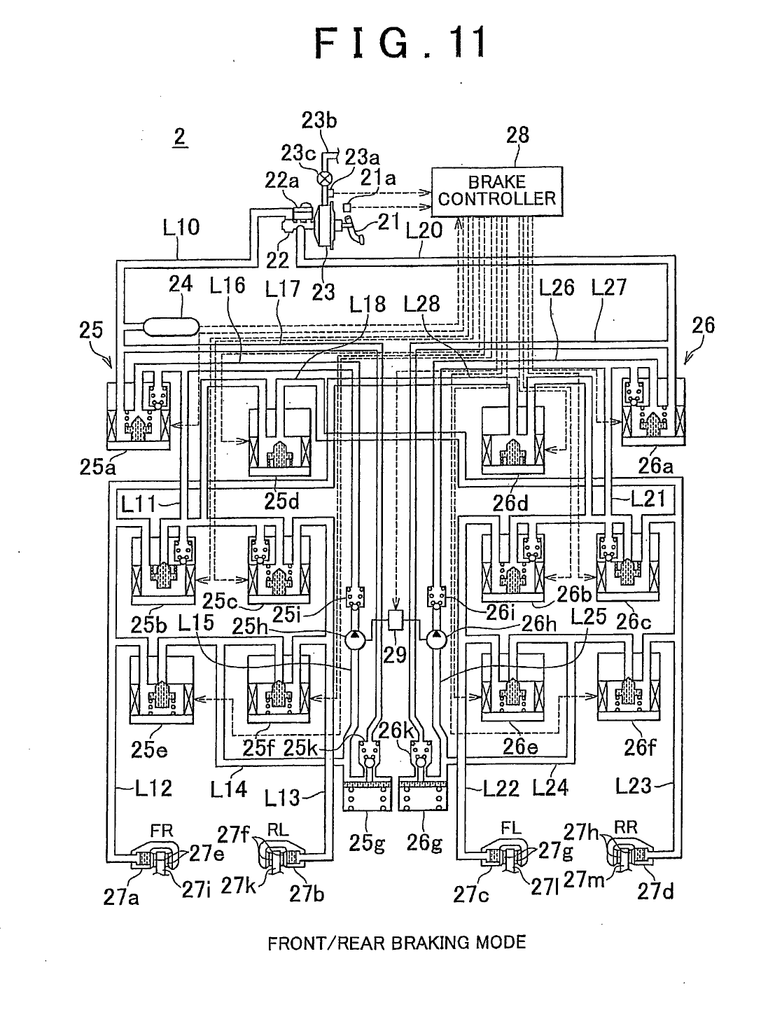

Note that in the above first to fourth embodiments, the first connecting line L18 and the second connecting line L28 are arranged so that, in the front/rear braking mode, the front wheel braking force is exerted on the front wheels (not shown) of the vehicle CA by the brake fluid OIL1 in the first system 25 and the rear wheel braking force is exerted on the rear wheels (not shown) of the vehicle CA by the brake fluid OIL2 in the second system 26; however, the embodiments of the invention are not limited to this configuration. For example, the configuration may be the one according to an alternative embodiment to the first embodiment as shown in FIG. 10 and FIG. 11. This alternative embodiment differs from the above described first embodiment in the following points. Specifically, it is applicable that one end of the first connecting line L18 is connected to the upstream side of the holding solenoid valve 25b and holding solenoid valve 25c within the first system 25, and the other end is connected between the holding solenoid valve 26c and the RR cylinder 27d, that is, the downstream side of the holding solenoid valve 26c within the second system 26. In this case, the first changeover valve 25d allows or interrupts connection between the master cut solenoid valve 25a of the first system 25 and the RR cylinder 27d. On the other hand, it is applicable that one end of the second connecting line L28 is connected to the upstream side of the holding solenoid valve 26b and holding solenoid valve 26c within the second system 26, and the other end is connected between the holding solenoid valve 25b and the FR cylinder 27a, that is, the downstream side of the holding solenoid valve 25b within the first system 25. In this case, the second changeover valve 26d allows or interrupts connection between the master cut solenoid valve 26a of the second system 26 and the FR cylinder 27a. Thus, as shown in FIG. 11, it is applicable that, in the front/rear braking mode, the first changeover valve 25d and the second changeover valve 26d are opened, the holding solenoid valve 25b of the first system 25 is closed, the holding solenoid valve 25c of the first system 25 is opened, the holding solenoid valve 26b of the second system 26 is opened, and the holding solenoid valve 26c of the second system 26 is closed, so the rear braking force is exerted on the rear wheels of the vehicle CA by the brake fluid OIL1 in the first system 25, and the front wheel braking force is exerted on the front wheels of the vehicle CA by the brake fluid OIL2 in the second system 26.

In addition, in the above third and fourth embodiments, the regenerative braking system 4 is provided so that a regenerative braking force is exerted on the front wheels of the vehicle CA; however, the embodiments of the invention are not limited to this configuration. For example, the regenerative braking system 4 may exert a regenerative braking force on the rear wheels (not shown) of the vehicle CA. In this case, in the distribution priority mode, the target regenerative braking force BFr* is set on the basis of the required rear wheel braking force BF*r, and the second applied braking force is set on the basis of the effective regenerative braking force BTK. In addition, in the fuel economy priority mode, it is determined whether the effective regenerative braking force BTK is larger than or equal to a value obtained by subtracting the rear wheel master pressure braking force BFpmcr from the required rear wheel braking force BF*r. When the effective regenerative braking force BTK is larger than or equal to a value obtained by subtracting the rear wheel master pressure braking force BFpmcr from the required rear wheel braking force BF*r, the first applied braking force is set on the basis of the effective regenerative braking force BTK. When the effective regenerative braking force BTK is smaller than a value obtained by subtracting the rear wheel master pressure braking force BFpmcr from the required rear wheel braking force BF*r, the second applied braking force is set on the basis of the effective regenerative braking force BTK.

As described above, the braking system according to the embodiments of the invention is useful for a braking system that includes a first braking system that exerts a braking force on a right front wheel and a left rear wheel and a second braking system that exerts a braking force on a left front wheel and a right rear, wheel. Particularly, the braking system according to the embodiments of the invention is able to exert a braking force on a set of diagonally opposite wheels of a vehicle and is suitable for distributing a braking force between a front wheel braking force and a rear wheel braking force.

1. A braking system that pressurizes a hydraulic fluid in accordance with driver's braking operation to exert a pressure braking force on a vehicle, the braking system comprising:
a brake pedal that is operated by the driver;
an operating pressure apply unit that applies an operating pressure to the hydraulic fluid in accordance with driver's operation of the brake pedal;
a first system that supplies the pressurized hydraulic fluid to a right front wheel cylinder provided for a right front wheel and a left rear wheel cylinder provided for a left rear wheel;
a second system that supplies the pressurized hydraulic fluid to a left front wheel cylinder provided for a left front wheel and a right rear wheel cylinder provided for a right rear wheel;
a right-front holding valve that is provided upstream of the right front wheel cylinder within the first system;
a left-rear holding valve that is provided upstream of the left rear wheel cylinder within the first system;
a left-front holding valve that is provided upstream of the left front wheel cylinder within the second system;
a right-rear holding valve that is provided upstream of the right rear wheel cylinder within the second system;
a first connecting line that connects an upstream side of the right-front holding valve and the left-rear holding valve within the first system to any one of a position between the left-front holding valve and the left front wheel cylinder or a position between the right-rear holding valve and the right rear wheel cylinder;
a second connecting line that connects an upstream side of the left-front holding valve and the right-rear holding valve within the second system to any one of a position between the left-rear holding valve and the left rear wheel cylinder or a position between the right-front holding valve and the right front wheel cylinder;
a first changeover valve that is provided in the first connecting line; and
a second changeover valve that is provided in the second connecting line, wherein the first connecting line connects, when the first changeover valve is open, an upstream side of the right-front holding valve and the left-rear holding valve within the first system to a position between the left-front holding valve and the left front wheel cylinder, and the second connecting line connects, when the second changeover valve is open, an upstream side of the left-front holding valve and the right-rear holding valve within the second system to a position between the left-rear holding valve and the left rear wheel cylinder, or
the first connecting line connects, when the first changeover valve is open, an upstream side of the right-front holding valve and the left-rear holding valve within the first system to a position between the right-rear holding valve and the right-rear wheel cylinder, and the second connecting line connects, when the second changeover valve is open, an upstream side of the left-front holding valve and the right-rear holding valve within the second system to a position between the right-front holding valve and the right-front wheel cylinder.

2. The braking system according to claim 1, further comprising:
a control unit that at least controls opening and closing of each of the valves, wherein
the control unit switches a braking mode between a front/rear braking mode and a diagonal braking mode,
in the front/rear braking mode, the first changeover valve and the second changeover valve are opened, one of the right-front holding valve and the left-rear holding valve which is connected to the second connecting line is closed, and the other of the right-front holding valve and the left-rear holding valve is opened, and one of the left-front holding valve and the right-rear holding valve which is connected to the first connecting line is closed, and the other of the left-front holding valve and the right-rear holding valve is opened, and
in the diagonal braking mode, the first changeover valve and the second changeover valve are closed, the right-front holding valve and the left-rear holding valve are opened, and the left-front holding valve and the right-rear holding valve are opened.

3. The braking system according to claim 2, further comprising:
an abnormality detecting unit that detects an abnormality of at least any one of the first system and the second system, wherein
the control unit switches the braking mode to the front/rear braking mode when no abnormality is detected, and switches the braking mode to the diagonal braking mode when the abnormality is detected.

4. The braking system according to claim 2, further comprising:
a required braking force setting unit that sets a required braking force in accordance with the driver's braking operation; and
a pressurizing unit that respectively pressurizes a first system hydraulic fluid in the first system and a second system hydraulic fluid in the second system on the basis of the set required braking force, and applies pressures respectively to the first system hydraulic fluid and the second system hydraulic fluid, wherein
the control unit performs pressurizing control such that the pressures applied respectively to the first system hydraulic fluid and the second system hydraulic fluid by the pressurizing unit are separately controlled.

5. The braking system according to claim 4, further comprising:
a distribution ratio setting unit that sets a front/rear distribution ratio, which is the ratio between a front wheel braking force exerted on the front wheels of the vehicle and a rear wheel braking force exerted on the rear wheels of the vehicle for the braking force exerted on the vehicle in the front/rear braking mode, wherein
the control unit performs the pressurizing control on the basis of the set front/rear distribution ratio.

6. The braking system according to claim 5, further comprising:
an acceleration detecting unit that detects an acceleration of the vehicle, wherein
the distribution ratio setting unit sets the front/rear distribution ratio on the basis of the detected acceleration.

7. The braking system according to claim 5, further comprising:
a regenerative braking unit that exerts a regenerative braking force on at least any one of the front wheels of the vehicle and the rear wheels of the vehicle; and
a regenerative braking force setting unit that sets a target regenerative braking force, wherein
the control unit performs the pressurizing control when the sum of the pressure braking force based on the operating pressure and the regenerative braking force based on the set target regenerative braking force is smaller than the set required braking force.

8. The braking system according to claim 7, wherein
in the front/rear braking mode, the control unit at least switches a regenerative mode of the regenerative braking unit between a distribution priority mode and a fuel economy priority mode, and the regenerative braking force setting unit sets the target regenerative braking force so as to be larger in the fuel economy priority mode than in the distribution priority mode.

9. The braking system according to claim 8, wherein
the regenerative mode is switched on the basis of at least any one of a state of a deceleration of the vehicle and a frictional condition of a road surface on which the vehicle runs.

10. A braking system that pressurizes a hydraulic fluid in accordance with driver's braking operation to exert a pressure braking force on a vehicle, the braking system comprising:
a brake pedal that is operated by the driver;
an operating pressure apply unit that applies an operating pressure to the hydraulic fluid in accordance with driver's operation of the brake pedal;
a first system that supplies the pressurized hydraulic fluid to a right front wheel cylinder provided for a right front wheel and a left rear wheel cylinder provided for a left rear wheel;
a second system that supplies the pressurized hydraulic fluid to a left front wheel cylinder provided for a left front wheel and a right rear wheel cylinder provided for a right rear wheel;
a right-front holding valve that is provided upstream of the right front wheel cylinder within the first system;
a left-rear holding valve that is provided upstream of the left rear wheel cylinder within the first system;
a left-front holding valve that is provided upstream of the left front wheel cylinder within the second system;
a right-rear holding valve that is provided upstream of the right rear wheel cylinder within the second system;
a first connecting line that connects an upstream side of the right-front holding valve and the left-rear holding valve within the first system to any one of a position between the left-front holding valve and the left front wheel cylinder or a position between the right-rear holding valve and the right rear wheel cylinder;
a second connecting line that connects an upstream side of the left-front holding valve and the right-rear holding valve within the second system to any one of a position between the left-rear holding valve and the left rear wheel cylinder or a position between the right-front holding valve and the right front wheel cylinder;
a first changeover valve that is provided in the first connecting line;
a second changeover valve that is provided in the second connecting line;
a control unit that at least controls opening and closing of each of the valves; and
an abnormality detecting unit that detects an abnormality of at least any one of the first system and the second system,
wherein the control unit switches a braking mode from a front/rear braking mode to a diagonal braking mode, when the abnormality is detected.

11. (canceled)
